(19) United States
(12) Patent Application Publication
(10) Pub. No.: US 2023/0246735 A1
(43) Pub. Date: Aug. 3, 2023

(54) SCHEDULING AND RETRANSMISSION IN CENTRAL UNITS AND DISTRIBUTED UNITS

(71) Applicant: Cohere Technologies, Inc., San Jose, CA (US)

(72) Inventors: Shlomo Selim Rakib, San Jose, CA (US); Shachar KONS, San Jose, CA (US); Naveen RAWAT, San Jose, CA (US); Paul LIND, San Jose, CA (US)

(21) Appl. No.: 18/295,459

(22) Filed: Apr. 4, 2023

Related U.S. Application Data
(63) Continuation of application No. PCT/US2021/071730, filed on Oct. 5, 2021.
(60) Provisional application No. 63/087,822, filed on Oct. 5, 2020.

(51) Int. Cl. H04L 1/00; H04L 1/1812; H04L 1/08; H04L 5/00

(52) U.S. Cl. CPC H04L 1/0027; H04L 1/0003; H04L 1/08; H04L 1/1812; H04L 5/0053

(57) ABSTRACT

Methods, systems and devices for wireless communication are described. One example method includes determining, using resources in a wireless network, a schedule of transmissions between the wireless network and one or more user devices, and controlling the transmissions according to the schedule. The resources are distributed between a central unit (CU) and a distributed unit (DU) according to a resource partitioning scheme. The DU is configured to handle a first set of protocol layers of a communication protocol stack implemented in the wireless network according to a layer partitioning scheme and the CU is configured to handle a second set of protocol layers of the communication protocol stack according to the layer partitioning scheme. The first set of protocol layers excludes an upper medium access control (MAC) layer. The second set of protocol layers excludes a physical layer.

### CROSS-REFERENCE TO RELATED APPLICATION

This patent document is a continuation of PCT Application No. PCT/US2021/071730 entitled “SCHEDULING AND RETRANSMISSION IN CENTRAL UNITS AND DISTRIBUTED UNITS” filed on Oct. 5, 2021, which claims priority to U.S. Provisional Application No. 63/087,822 filed on Oct. 5, 2020, the disclosure of which is hereby incorporated by reference herein in its entirety. The entire contents of the aforementioned patent application is incorporated by reference as part of the disclosure of this patent document.

### TECHNICAL FIELD

The present document relates to wireless communication.

### BACKGROUND

Due to an explosive growth in the number of wireless user devices and the amount of wireless data that these devices can generate or consume, current wireless communication networks are fast running out of bandwidth to accommodate such a high growth in data traffic and provide high quality of service to users.

Various efforts are underway in the telecommunication industry to come up with next generation of wireless technologies that can keep up with the demand on performance of wireless devices and networks. Many of those activities involve situations in which a large number of user devices may be served by a network.

### SUMMARY

This document discloses techniques that may be used by wireless networks to achieve several operational improvements.

In one example aspect, a wireless communication system is disclosed. The method includes determining, using resources in a wireless network, a schedule of transmissions between the wireless network and one or more user devices; and controlling the transmissions according to the schedule. The resources are distributed between a central unit (CU) and a distributed unit (DU) according to a resource partitioning scheme. The DU is configured to handle a first set of protocol layers of a communication protocol stack implemented in the wireless network according to a layer partitioning scheme and the CU is configured to handle a second set of protocol layers of the communication protocol stack according to the layer partitioning scheme. The first set of protocol layers excludes an upper medium access control (MAC) layer. The second set of protocol layers excludes a physical layer.

In another example aspect, a wireless system is disclosed in which network-side protocol stack is partitioned into a high MAC that is implemented in a CU and a low MAC that is implemented in a DU. The high MAC and low MAC communicate via an interface, called F3 interface. In various embodiments, the information exchanged between the high MAC and low MAC includes: Scheduling and spatial multiplexing information, Multi-user spatial precoding coefficients, Data & Control, (from high MAC to low MAC), and data/control, downlink channel information (CSI reports), UL channel estimation/information and ACK/NACK messages from low MAC to high MAC. In another example aspect, the wireless system includes a partitioned scheduler that uses CU resources and DU resources. These resources may be, for example, a CU scheduler and a DU scheduler. The CU scheduler may be responsible for modulation and coding scheme (MCS) prediction over the CU-DU latency, transmissions for multi-user over different spatial layers, and co-scheduling transmissions for multiple DU. The DU scheduler may be responsible for single user devices for time critical transmissions.

In yet another example aspect of the wireless system, hybrid automatic repeat request ARQ (HARQ) may be handled by disabling HARQ by ignoring NACK at low MAC & PHY. Instead, lower MCS and apply automatic scheduling of additional retransmissions when MCS cannot be lowered (proactive HARQ). The HARQ may be passed from low MAC to high MAC to reduce RLC retransmission latency. The DU scheduler may schedule HARQ retransmissions in case that sufficient resources are available. Otherwise, it may ignore NACK indicator from low MAC and PHY.

In yet another example aspect, a split 2 architecture may be implemented in which a packet data convergence protocol (PDCP) layer may be implemented at CU and RLC and lower layers may be implemented at DU. These layers may communicate using an F1 interface. A duplicated radio link control (RLC) layer may be implemented at both sides of the F1 interface. The F1 interface is modified to include scheduler information along with PDCP data and control information. In one advantageous aspect, the duplicate RLC layer allows for re-use of the standardized (or legacy) F1 interface for the inter-layer communication.

In yet another example aspect, a wireless communication system that implements the above-described methods is disclosed.

In yet another example aspect, a wireless system in which one or more of the above described methods are implemented is disclosed.

In yet another example aspect, the method may be embodied as processor-executable code and may be stored on a computer-readable program medium.

These, and other, features are described in this document.

### DESCRIPTION OF THE DRAWINGS

Drawings described herein are used to provide a further understanding and constitute a part of this application. Example embodiments and illustrations thereof are used to explain the technology rather than limiting its scope.

FIGS. 1A-1F show examples of wireless networks and systems.

FIG. 2 shows a wireless network architecture implementing a central unit (CU) and one or more distributed units (DUs).

FIG. 3 shows an example of a partitioned scheduler embodiment.

FIG. 4 is a flowchart for an example method of facilitating wireless communication.

FIG. 5A shows an example of a protocol layer split.

FIG. 5B shows another example of a protocol layer split.

FIG. 6 shows an example of data encryption in the PDCP layer.

FIG. 7 shows an architecture of a scheduler implementation.

FIG. 8 shows another architecture of a scheduler implementation.

FIG. 9 shows yet another architecture of a scheduler implementation.

FIG. 10 shows an example embodiment of a DU.

FIG. 11 shows an example embodiment that fits within an Open Radio Access Network (O-RAN) framework.

FIG. 12 shows another example embodiment that fits within an O-RAN framework.

FIG. 13 shows yet another example embodiment that fits within an O-RAN framework.

FIGS. 14A and 14B show two different examples of splitting implementation resources between a CU and a DU.

FIG. 15A shows an example of the F1-C signaling bearer protocol stack.

FIG. 15B shows an example of the transport network layer for data streams over F1.

FIG. 16 shows various embodiment options for protocol stack handling.

FIG. 17 shows an example of a delay-Doppler domain channel estimation.

FIG. 18 shows an example of delay-Doppler domain channel representation.

FIG. 19A shows an example of channel modeling.

FIG. 19B shows an example of prediction in delay-Doppler domain.

FIG. 20 shows an example of channel sensing in delay-Doppler domain.

FIGS. 21A-25B show additional details of Orthogonal Time Frequency Space (OTFS) transformation and modulation.

FIG. 26 shows an example system architecture in a wireless network.

FIG. 27 shows a hardware platform that may be used for implementing various functions disclosed in the present document.

### DETAILED DESCRIPTION

To make the purposes, technical solutions and advantages of this disclosure more apparent, various embodiments are described in detail below with reference to the drawings. Unless otherwise noted, embodiments and features in embodiments of the present document may be combined with each other.

Section headings are used in the present document to improve readability of the description and do not in any way limit the discussion or the embodiments to the respective sections only. Furthermore, certain standard-specific terms are used for illustrative purpose only, and the disclosed techniques are applicable to any wireless communication systems.

### Initial Discussion

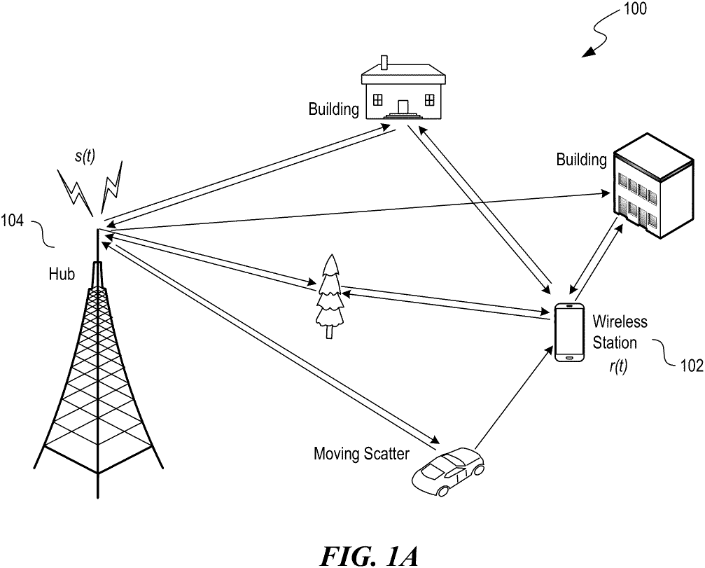

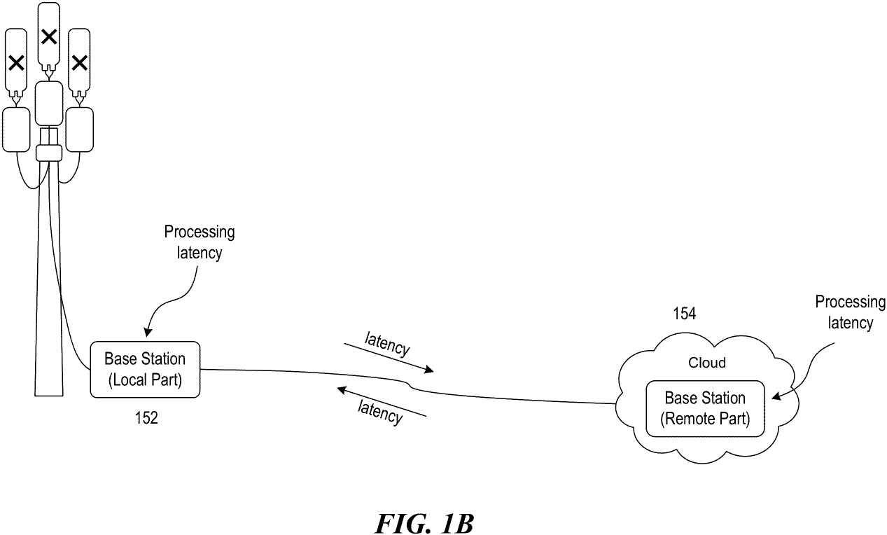

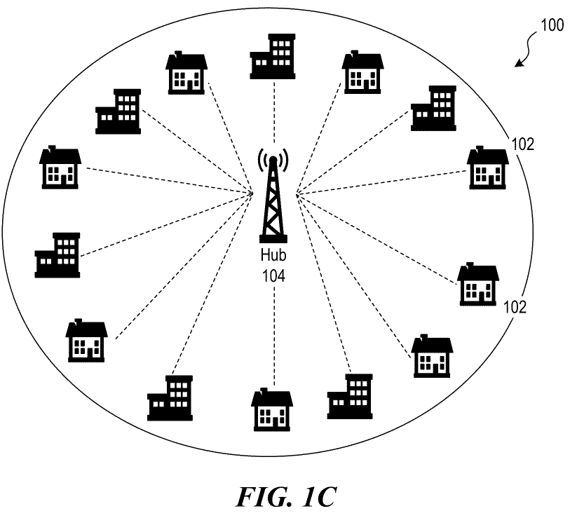

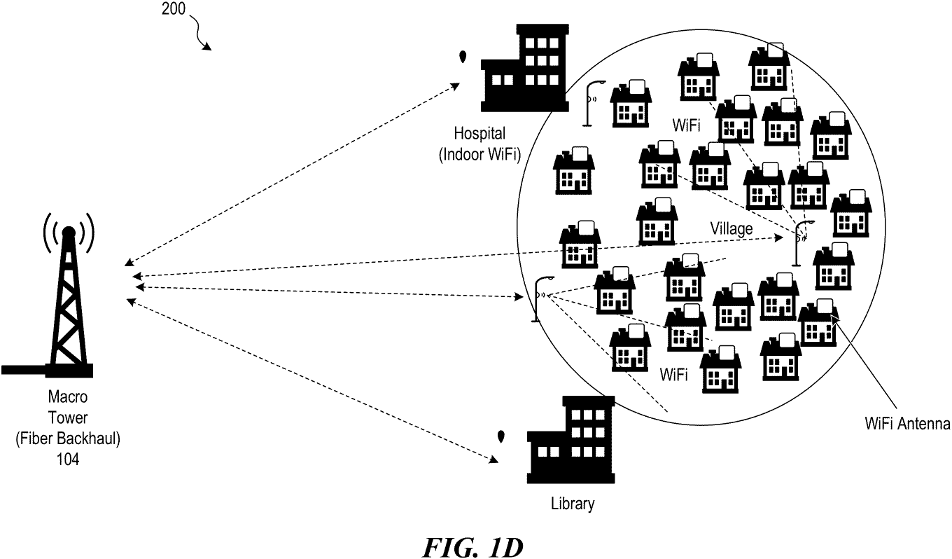

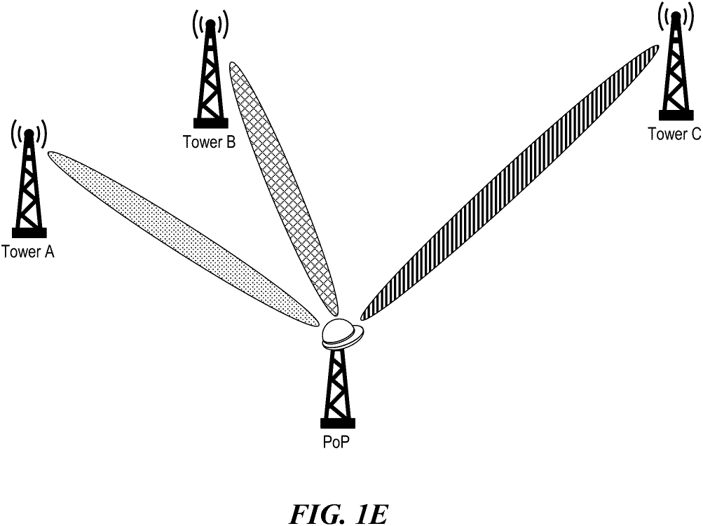

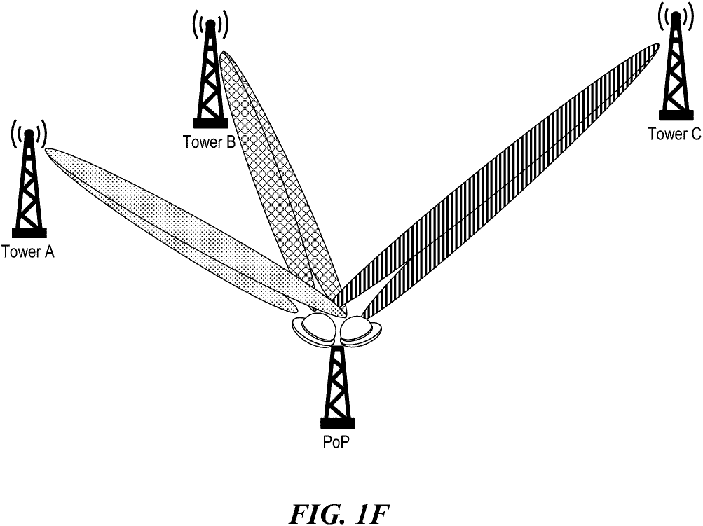

FIG. 1A shows an example of a wireless communication system 100 in which a transmitter device 102 transmits signals to a receiver device 104. The signals may undergo various wireless channels and multipaths, as depicted. Some reflectors such as buildings and trees may be static, while others such as cars, may be moving scatterers. The transmitter device 102 may be, for example, a user device, a mobile phone, a tablet, a computer, or another Internet of Things (IoT) device such as a smartwatch, a camera, and so on. The receiver device 104 may be a network device such as the base station. The signals transmitted from the base station to the transmitter 102 may experience similar channel degradations produced by static or moving scatterers.

A base station in a wireless Radio Access Network (RAN), such as Third Generation Partnership Project, 3GPP’s Long Term Evolution LTE or 5G, is typically located within the cell’s area and locally controlling the downlink and uplink transmissions. In recent years, there has been more motivation to move parts of the base station to a remote central location (also known as the “cloud”), for different reasons such as shared computing power, coordinated transmissions, easier maintenance, etc. However, the main drawback of this approach, is the introduced latency of transferring information back and forth from the remote central location to the local part of the base station within the cell.

FIG. 1B shows an example of such a system. In the depicted configuration, base station functionality is implemented partly locally (152) and partly in the remote cloud (154). The total latency is introduced by processing in the local and remote parts and by the communication back and forth from the remote location.

FIG. 1C shows an example of a fixed wireless access system 100. A hub 102, that includes a transmission facility such as a cell tower, is configured to send and receive transmissions to/from multiple locations 104 (only two of which have been shown with the reference numeral for simplicity). For example, the locations could be user premises or business buildings. In some cases, the locations 104 may be transmission towers of respective cells that are controlled by a centralized cloud-based computational facility such as described in the present document, represented as hub 102 in FIG. 1C). The described embodiments can be implemented at the hub 102 or at transceiver apparatus located at the locations 104.

FIG. 1D shows another example of a fixed access wireless communication system 100 in which hops are used to reach users. For example, one cell tower may transmit/receive from another cell tower, which would then relay the transmissions between the principle cell tower and the users, thus extending range of the fixed wireless access system. A backhaul may connect the transmission tower 104 with an aggregation router. For example, in one configuration, a 10 Gbps fiber connection may be used to feed data between a base station at a hub and a fiber hub aggregation router. In one advantageous aspect, deployment of this technology can be achieved without having to change any network bandwidth characteristics for harder to reach areas by using the hub/home access point (AP) configuration as a launch point. Some techniques disclosed herein can be embodied in implementations at the macro tower 104 or at transceiver apparatus located at the other locations. Furthermore, the disclosed techniques may be implemented for wireless communication among various macro towers that use wireless backhaul connections in place of, or in addition to, the fiber backhaul.

For stationary devices, the beams may be set at fixed directions, pointing to the devices. An example of such a system, is a cellular backhaul, where a hub, connected to a fiber feed, is communicating with remote towers (which have no fiber connection). FIG. 1E illustrates such an example. As shown therein, the hub, denoted as a PoP (Point of Presence), is connected to a fiber (not explicitly shown) and communicates with remote towers using a Luneburg antenna and three different beams pointing towards these towers. If the Luneburg has dual-polarization input feeds and the remote antennas are dual-polarized as well, a two-layer link may be established between the hub and each tower.

Dual polarization antennas and multiple antennas at the remote devices and the hub may all be used to create a multi-layer link between the hub and the devices. Note, that multiple antennas should be spatially separated for a good quality multi-layer link. FIG. 1F illustrates an example of such a system.

The techniques described in the present document may be implemented by the devices in the wireless communication systems shown in FIGS. 1A-1F. The terms “transmitter” and “receiver” are simply used for convenience of explanation and, as further described herein, depending on the direction of transmission (uplink or downlink), the network station may be transmitting or receiving and user device may be receiving or transmitting during use.

Transmissions in a wireless network include transmissions from a base station to one or more user devices, sometimes called downlink transmissions and transmissions from the user devices, sometimes called uplink transmissions. In 3GPP terminology, user devices are called “user equipment” UE (e.g., devices 102 in FIGS. 1A and 1C). The various uplink and downlink transmissions may include user data transmissions or control transmissions. With a few exceptions (e.g., initial access or random access), all other transmissions in the wireless network are typically controlled by a network-side function that schedules these transmissions ahead of time. This function is sometimes called a scheduler function. Due to high bandwidth and real-time, low latency requirements in a typical wireless network, a scheduler typically requires a large amount of computations resources to collect system data on a millisecond by millisecond basis, process the data, and generate schedules for upcoming transmissions. In many wireless networks, schedules are organized into time segments. For example, in 3GPP, a transmit time interval (TTI) which may be 10, 20, 40 or 80 milliseconds in duration, is used as a unit of time for scheduling.

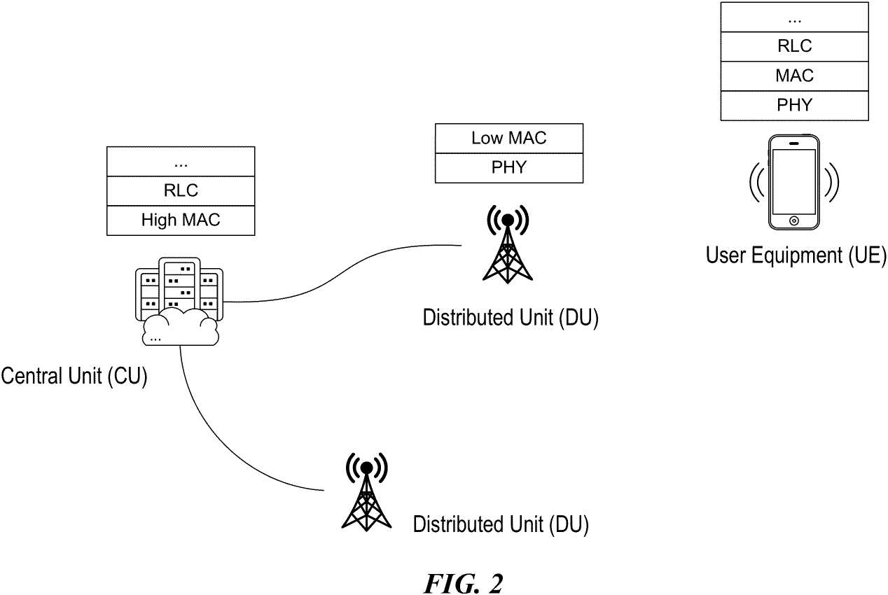

FIG. 2 shows an example of a wireless network architecture in which one or more user devices (UEs) are configured with a protocol stack that includes a physical layer (PHY), a medium access control layer (MAC), a radio link control layer (RLC) and other layers above it (e.g., application layer, session layer etc.). Notably, on the network side, the network-side protocol stack is split into multiple DUs that communicate using a wired or wireless connection with a CU. In the depicted embodiments, a first DU is shown to implement lower layer MAC and PHY functions, while the corresponding CU side stack implements higher layer MAC, the RLC layer, and other higher layers. Another DU simply acts as a radio receiver/transmitter by implementing a minimum set of PHY layer functionality. As can be seen from this architecture, the CU DU split allows network deployments in which amount of network resources available at the DU location (typically close to UEs, e.g., in a cell tower) are used to determine a protocol stack split between the DU and a CU (typically in a location away from a cell tower, but sometimes at the base of the cell tower in case that sufficient space and environmental facility is available to set up a CU).

The system architecture shown in FIG. 2 has several advantages, which include cost, maintainability, and coordinated scheduling of transmissions between multiple DUs. However, the additional latency of transferring data back and forth between the CU and the DU, which may be as high as tens of milliseconds, introduces some challenges.

One of these challenges is related to the Hybrid Automatic Repeat reQuest (HARQ) mechanism, implemented in the PHY for retransmissions of erroneous packets, in response to a feedback from the target receiver. The problem arises from the fact, that if only the CU schedules transmissions, the DU will not be able to schedule PHY HARQ retransmissions. In an example, retransmissions of erroneous (or non-received) packets is also handled by higher layers than the PHY. The RLC layer also has a mechanism for detecting missing Protocol Data Units (PDU) and requesting that they will be retransmitted.

Recently, a new architecture for network-side implementation of various functionalities, including scheduler tasks, has been proposed and adopted by 3GPP. As further discussed in this document, this architecture includes the use of central units (CU) that are typically placed closer to core network and are responsible for managing higher layer protocol stacks (e.g., radio link layer and above), and one or more distributed units (DUs) that are located close to the radio access network (RAN) and are responsible for managing physical layer functions and some medium access control layer (MAC) functions.

Various embodiments further described in the present document advantageously use the CU/DU architecture to further improve network operations as described throughout the present document. In an example, this may be achieved by using a system with a central scheduling unit, which can be configured to implement retransmissions with and without using the PHY HARQ.

### Example Embodiments

The present document describes, among other things, techniques that enable various embodiments to use network resources such as computational resources or transmission resources to perform network functions such as scheduling of transmissions.

In some embodiments, the CU (e.g., the CU shown in FIG. 2) may be configured to:
predict the modulation and coding scheme (MCS) that is best suitable for the future channel conditions, at the time of the actual transmission;
reduce the predicted MCS by a fixed or adjustable amount, such that the rate of erroneous packets is reduced to a desired level; and
for transmissions, where the MCS is already low and cannot be further reduced to a desired rate of erroneous packets, schedule for every transmission, one or more additional transmissions in a similar way to the operation of the PHY HARQ. The additional transmissions may correspond to different HARQ schemes such a chase combining or incremental redundancy, where the same data or of different parity data is transmitted and used for soft combining at the receiver. Note, that the difference between this method and PHY HARQ is that the scheduler does not wait for any feedback from the receiver, whether a retransmission is needed, but rather always schedules it.

In some embodiments, the DU/CU may ignore the feedback from the receiver on the received packets, typically known as ACK/NACK (Acknowledged/Not Acknowledged). Any erroneous or missing packets, will be handled by requests and retransmissions on the RLC layer of the UE and CU.

In some embodiments, the DU may pass a NACK indication to the CU to initiate the RLC retransmissions earlier, without waiting for the RLC retransmission request from the UE.

In some embodiments, the scheduler will reduce the MCS of RLC retransmitted packets, even further than the original packet (if possible) to improve the probability of a successful reception. If the MCS is already low and cannot be reduced, additional RLC retransmissions may be scheduled automatically without waiting for a receiver feedback.

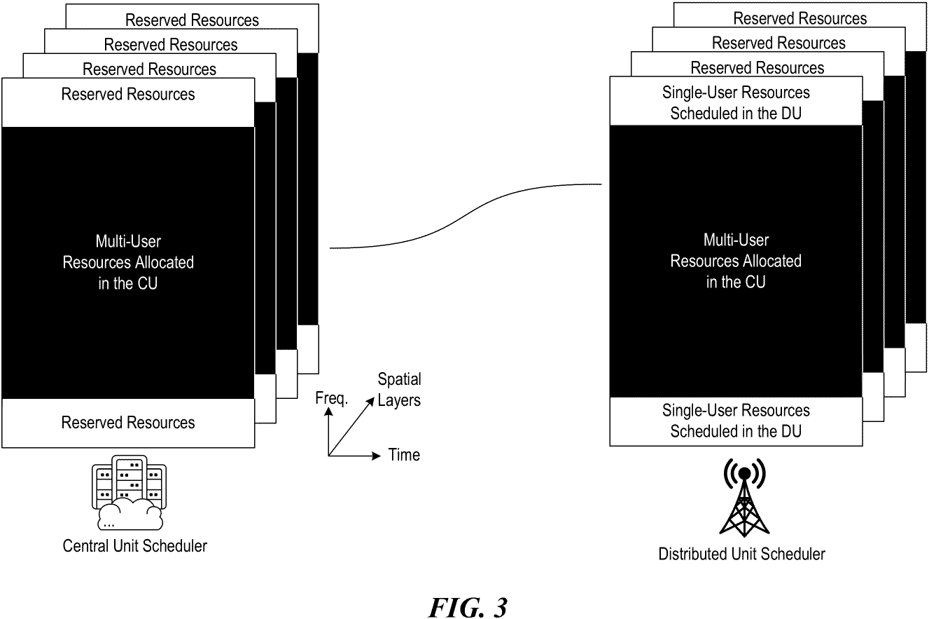

FIG. 3 shows an example partitioning of network resources between a CU scheduler (left) and one or more DU schedulers (right). The CU scheduler may operate on a three dimensional space that includes time (e.g., selection of time slots), frequency (e.g., selection of subcarriers to use for transmissions) and spatial layers (which layers to use for which transmissions). In the DU, the resources may focus more on a single user schedule that is implemented/executed by the DU. The drawing pictorially shows that a large amount of resources at DU could be freed up by transferring the corresponding responsibilities of scheduling for multiple UEs served by the DU to CU-side scheduling resources.

In some embodiments, the CU schedules its available resources for data and control transmissions for multi-users and the DU schedules transmissions for single-user time critical procedures, such as initial access, service requests and HARQ (as shown in FIG. 3).

In some embodiments, the resources available for scheduling may be split into two parts. This partition may be fixed (static) or dynamic (changing even every transmit interval). The first part of the available resources is used for scheduling transmissions at the CU. The other part of the available resources is used for scheduling transmissions at the DU. Using this method, if there are enough available resources at the DU scheduler, it may schedule PHY HARQ retransmissions, in response to receiving a NACK from a UE.

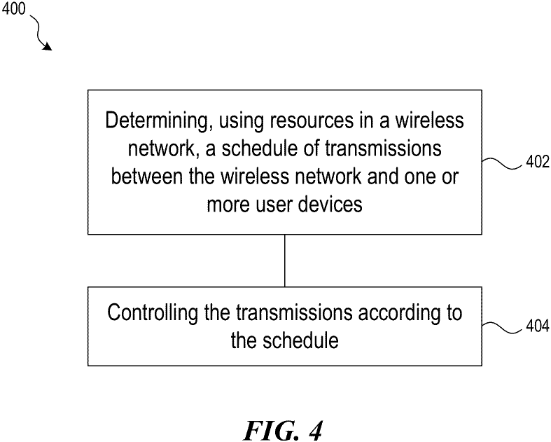

As shown in FIG. 4, a wireless communication method 400 may include determining (402), using resources in a wireless network, a schedule of transmissions between the wireless network and one or more user devices; and controlling (404) the transmissions according to the schedule. Here, the resources are distributed between a central unit (CU) and a distributed unit (DU) according to a resource partitioning scheme as described in the present document. Furthermore, the DU is configured to handle a first set of protocol layers of a communication protocol stack implemented in the wireless network according to a layer partitioning scheme and the CU is configured to handle a second set of protocol layers of the communication protocol stack according to the layer partitioning scheme. The first set of protocol layers excludes an upper medium access control (MAC) layer. The second set of protocol layers excludes a physical layer. The controlling 404 may include providing a schedule of transmission to the one or more user devices to follow.

In some embodiments, the layer partitioning scheme disables handling of hybrid automatic repeat requests (HARQ) by the DU.

In some embodiments, some or all transmissions in the wireless network are scheduled at the CU according to a scheduling operation.

In some embodiments, the scheduling operation comprises predicting a channel condition of a channel between the wireless network and a user device at a future time, and determining a modulation and coding scheme (MCS) for a future transmission at the future time on the channel based on the predicted channel condition.

In some embodiments, the determining the MCS includes adjusting the MCS to a lower value according to a target packet error rate.

In some embodiments, the scheduling operation further comprises scheduling additional transmissions for data being sent using the future transmission causing an increase in reliability of delivery of the data at the future time.

In some embodiments, the method 400 further comprises receiving an ACK/NACK transmission from the one or more wireless device, and refraining, in response to the ACK/NACK transmission, retransmitting data based on the ACK/NACK transmission from the first set of protocol layers.

In some embodiments, performing the retransmission includes one of (1) reducing a modulation and coding rate of the retransmission, or (2) scheduling additional retransmissions, in case that the modulation and coding rate is non-reducible.

In some embodiments, the resource partitioning scheme is a fixed resource partitioning scheme. For example, during network planning, amount of resources (computing power or physical space or the type of hardware platform used at DU) available at DU may be determined and a fixed amount of resources may be implemented at the DU, with remaining tasks being performed at the CU.

In some embodiments, the resource partitioning scheme is dynamically changing with a granularity. The dynamic change in resource partitioning may be communicated between DU and CU using a higher layer message.

In some embodiments, the granularity is one transmit time interval (TTI).

In some embodiments, the method 400 further comprises handling, by the DU, HARQ retransmissions based on an acknowledgement/negative acknowledgement (ACK/NACK) transmission received from the one or more user devices, selectively based on the resources available at the DU according to the resource partitioning scheme.

In some embodiments, the layer partitioning scheme configures the DU to handle initial access, service requests, and HARQ transmissions.

In some embodiments, the layer partitioning scheme configures the CU to handle remaining data and control transmissions.

In some embodiments, the CU implements the resource partitioning scheme with multiple DUs.

In some embodiments, the layer partitioning scheme comprises a first scheme in which the upper MAC layer and layers above the upper MAC layer are implemented at the CU and a lower MAC layer and layers below the lower MAC layer are implemented at the DU.

In some embodiments, further comprises establishing a communication interface between the upper MAC layer and the lower MAC layer, wherein the communication interface is configured to carry user data, control data, and scheduling information.

In some embodiments, the layer partitioning scheme comprises a second scheme in which a packet data convergence protocol (PDCP) layer and layers above the PDCP layer are implemented at the CU and a radio link control layer (RLC) and layers below the RLC layer are implemented at the DU.

In some embodiments, further comprises implementing, in a cloud, a duplicate copy of the RLC at the DU, wherein a communication between the PDCP layer and the RLC layer is compliant with a legacy protocol.

In some embodiments, the resources in the wireless network comprise transmission resources and/or computational resources.

In some embodiments, the CU is implemented using a cloud architecture and/or cloud computing resources.

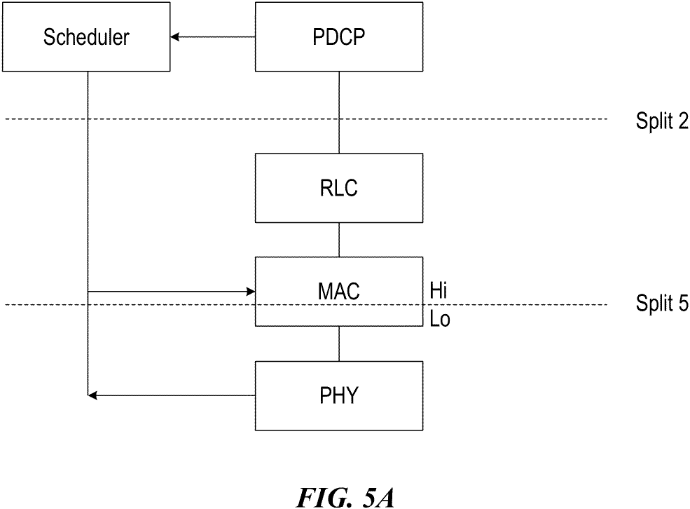

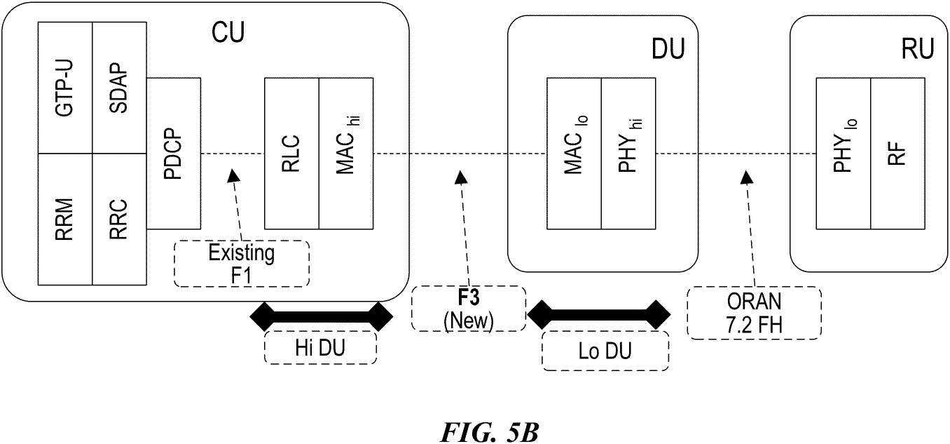

FIG. 5A shows an example of a protocol layer split. Two different splitting schemes, namely Split 2 and Split 5 are depicted. A typical wireless network protocol stack may include a physical layer (PHY), a medium access control (MAC) layer, which may be split into a high MAC and a low MAC sublayer, a radio link connection (RLC) layer and a packet data convergence protocol (PDCP) layer. As depicted, PDCP layer may provide information to a scheduler which controls operation of the MAC and PHY layers. In a Split 5 scheme, low MAC and PHY may be implemented by DU, while the upper layers (relative to the lower layers of low MAC and PHY) may be implemented by a CU. In a Split 2 arrangement, RLC, MAC and PHY may be implemented at the DU while the PDCP layer may be implemented by a CU.

FIG. 5B shows another example of the Split 5 protocol layer split, wherein the current CU/DU Split 2 architecture, which includes the F1 interface and management and configuration protocols, is retained, thereby simplifying the implementation. As shown in FIG. 5B, the CU in the Split 5 arrangement includes the legacy CU (comprising the PDCP, radio resource management, RRM and radio resource control RRC) that interfaces, via F1, with the RLC and higher MAC layer, and the DU in the Split 5 arrangement includes the lower MAC layer and the higher PHY layer. The Hi-Du and Lo-DU protocols are defined as shown in FIG. 5B. The CU and DU in the Split 5 arrangement are connected using the new F3 interface, which is detailed in the present document.

In some embodiments, the new Lo-DU, shown in FIG. 5B, is developed by starting with the local scheduler implementation, removing the RLC, much of the MAC layer, and the F1 protocol, retaining the remaining portions of the MAC and the L2/L1 interface, and adding the new blocks and messages. Similarly, the new Hi-DU is developed by removing the PHY interface and adding the Split 5 interfaces. The new CU and Lo-DU split is standardized using the new F3 interface, and modifying the existing management protocols (e.g., O1, OAM).

In some embodiments, the Split 5 downlink can be configured to implement a mini-scheduler, which enables certain grants (e.g., Random Access Response (RAR)) to be scheduled at Lo-DU in order to meet timing requirements. In other embodiments, scheduling requests (SRs) may be optimized by sending an initial (small) UL grant to the UE to retrieve initial data and/or the buffer status report (BSR).

In some embodiments, the Split 5 uplink can be configured such that the HARQ feedback drives the prediction algorithms. In this scenario, the user devices will need DL DCI (without a new data indicator (NDI)), which may be supplied by the proactive HARQ. In an example, then the user device receives the packet correctly (e.g., after one retry), the DCI retransmission may be dropped.

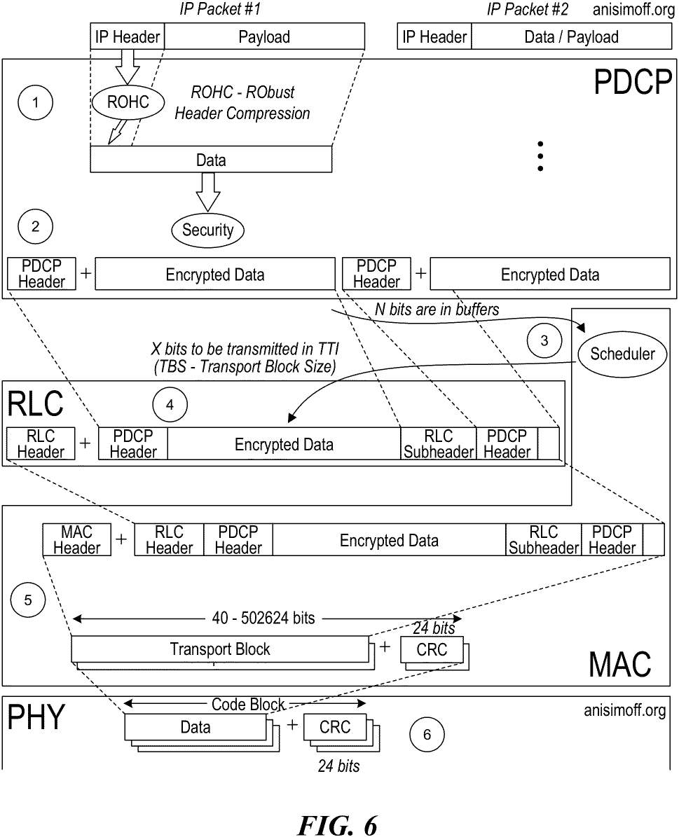

In some embodiments, the entire IP header is encrypted at the PDCP layer, as shown in FIG. 6. In the PDCP layer, at step 1, the header of an IP packet is transformed using robust header compression (ROHC), and then along with the payload, is encrypted to generate a PDCP packet at step 2. At step 3, the scheduler retrieves N bits from the packets with a PDCP header to generate a packet with an RLC header (at step 4), which is then reformatted into a packet with a MAC header that corresponds to a transport block (at step 5). At step 6, the data from the MAC layer in transformed to data in the PHY layer, for which CRC bits are generated.

In some embodiments, the PDCP encryption framework cannot perform user-packet inspections to aid quality-of-service (QoS) decisions. To that end, all QoS must be obtained from the 5G Core Network (5GCN).

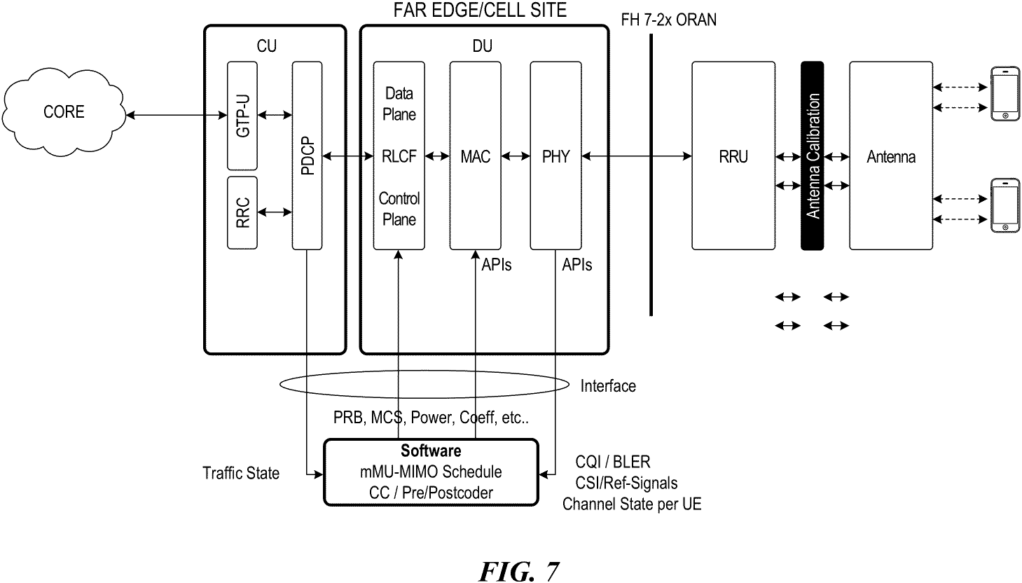

FIG. 7 shows an architecture of a scheduler implementation. From left to right in this architecture a core network may provide connectivity to a CU, which is communicatively coupled to one or more DUs. The DUs interface with a remote radio unit (RRU) that receives and transmit signals via antennas to multiple user devices. In addition, an antenna calibration function may be implemented at the interface between radio reception unit RRU and antennas.

The CU may include functional blocks for implementing the radio resource control (RRC) and PDCP functionalities, along with a general packet radio service tunneling protocol for user data (GTP-U). The DU, implemented at the edge or near a cell cite, includes a RLC (with a control plane and a data plane), coupled to a MAC implementation, coupled to a PHY implementation, that then communicates with the RRU through an interface such as the FH 7-2x interface specified by the O-RAN.

Various CU and DU functions such as the PDCP, RLC, MAC and PHY may be in communication with the scheduler that may be a software implementation. The data exchange may include information of traffic state (to / from core network), physical layer information such as modulation and coding scheme, signal power, channel quality information, bit error rate, reference signal processing results, and so on. The scheduler may process currently available data and generate a future schedule, e.g., as described in method 400, for future transmissions in the network. The scheduler may also control physical layer parameters of thee transmissions, including scheduling of reference signals.

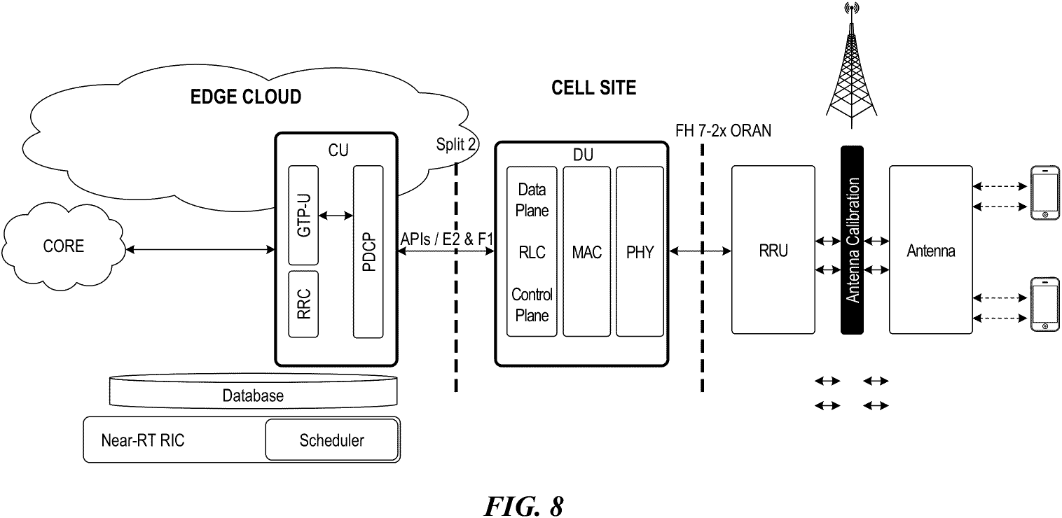

FIG. 8 shows another architecture of a scheduler implementation. Similar functional blocks are similarly named as in FIG. 8. However, one difference in FIG. 8 compared to FIG. 7 is that the scheduler is implemented in the edge cloud as a cloud function. Accordingly, the interactions between the scheduler and the DU occur through an interface across Split 2, which may be a newly defined interface.

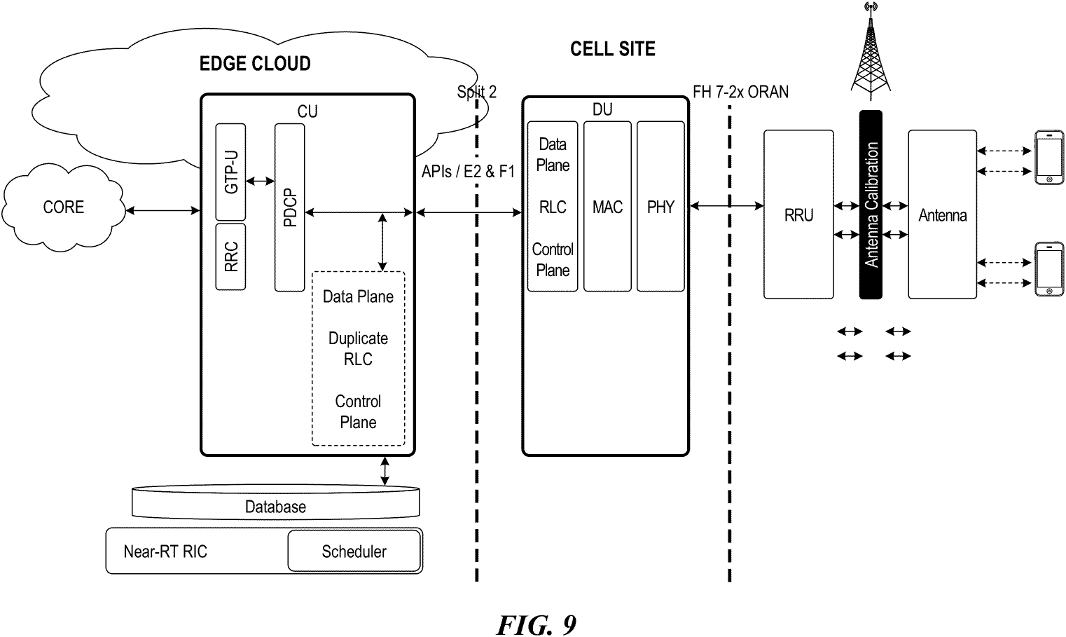

FIG. 9 shows yet another architecture of a scheduler implementation. Compared to FIGS. 7 and 8, in FIG. 9, the scheduler is implemented in the cloud using a duplicated RLC that handles data plan and control plane. The duplicated RLC may provide a protocol layer for formatting data transmissions to / from a databased under control of the scheduler and the network scheduling data.

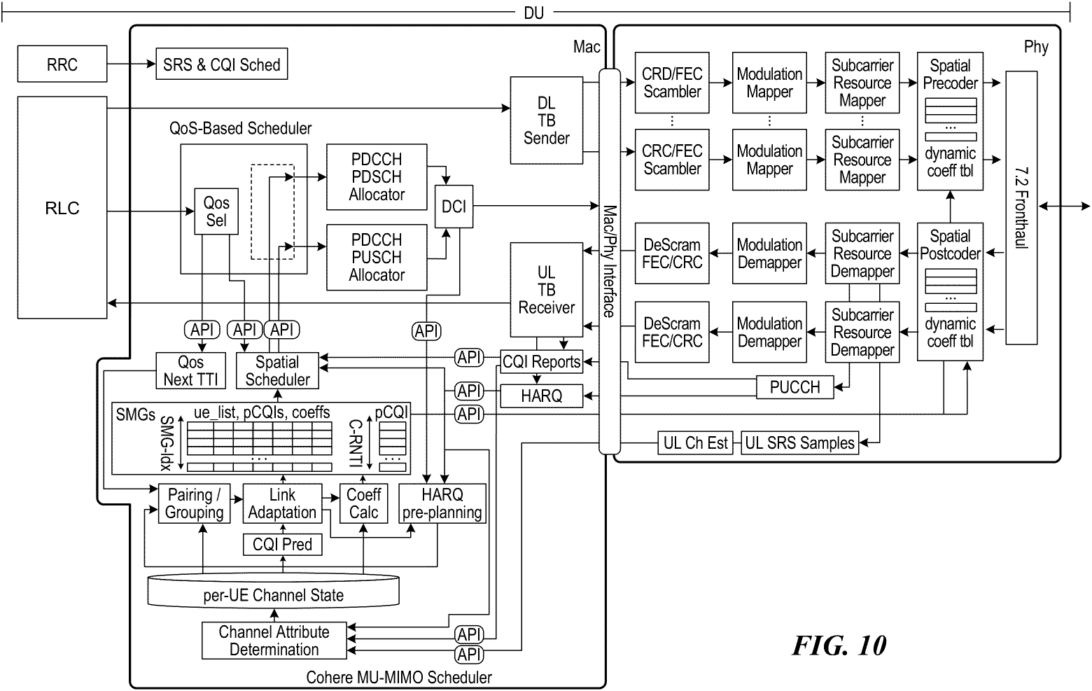

FIG. 10 shows an example embodiment of a DU, e.g., the DU shown in at least FIGS. 7-9. As shown therein, the DU includes the RRC, RLC, MAC and PHY layers. The MAC layer includes the multi-user multiple-input multiple-output (MU-MIMO) scheduler, which is configured to perform channel estimation, link adaptation, and scheduling. The MAC layer further includes the QoS-based scheduler, the transport block (TB) sender and receiver blocks, all of which interface with the RLC. The PHY layer includes multiple transmit chains, each of which comprise a CRC/ FEC scrambler, a modulation mapper, a subcarrier resource mapper, and a common spatial precoder for all the transmit chains.

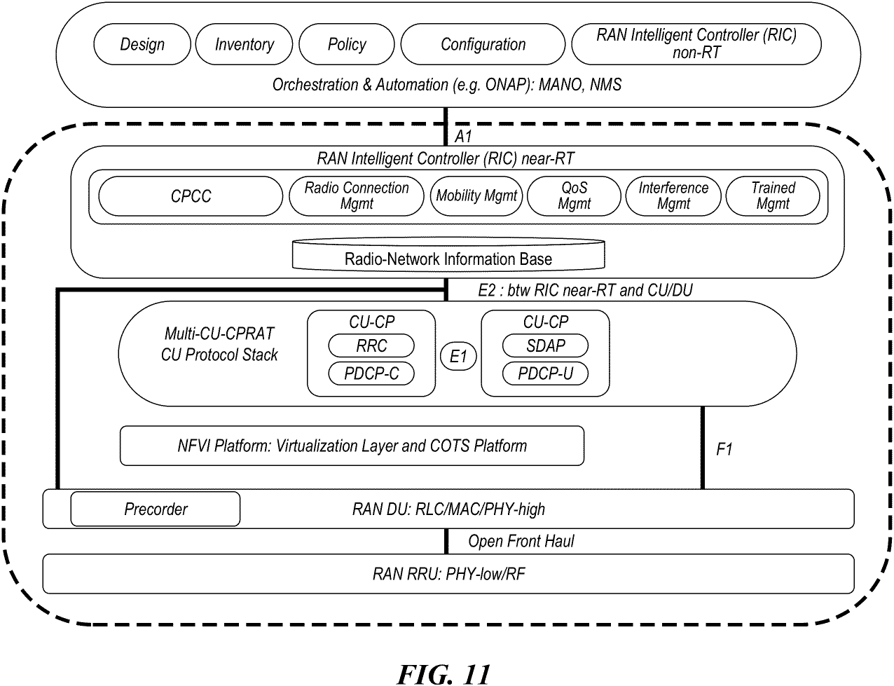

FIG. 11 shows an example embodiment that fits within an O-RAN framework. A Channel Prediction and Coefficient Computation (CPCC) function may be implemented by a RAN control, called RAN Intelligent Controller (RIC) in real time (RT) or near RT and implement functions such as radio connection management, mobility management, quality of service management, interference managed and training management. The RIC may interface with an upper layer function called orchestration and automation function. The RIC may interface with a lower layer function that performs CU functions by implementing one or more CU stacks for one or more CU functions. The RIC may also provide CPCC data to precoder implemented at the DU, which then controls transmissions to/from the RRU.

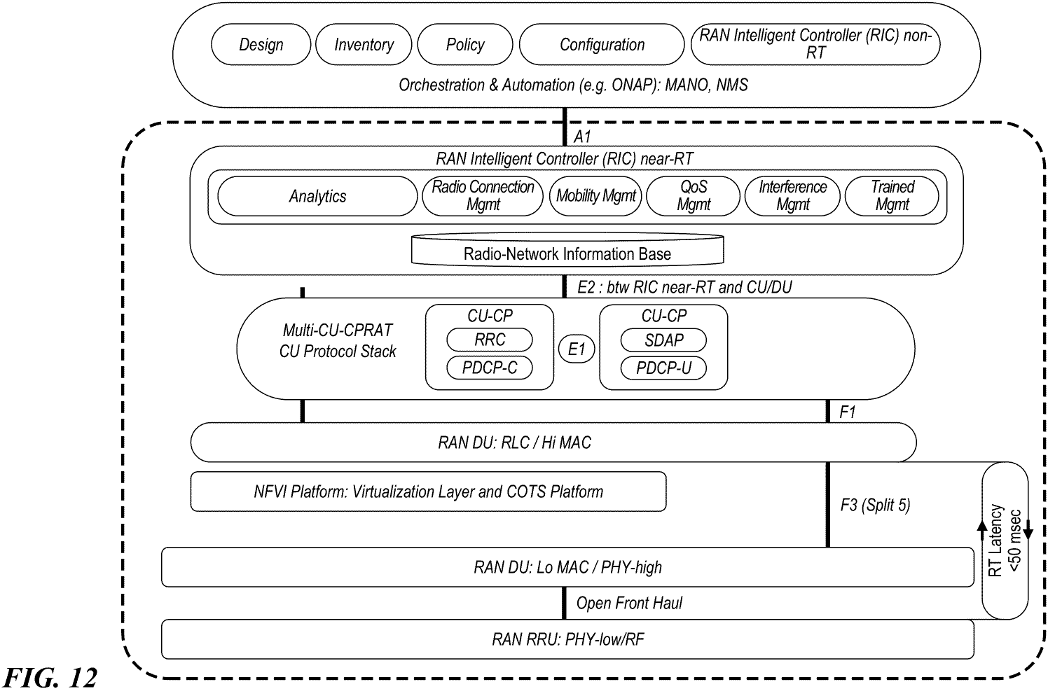

FIG. 12 shows another example embodiment that fits within an O-RAN framework. Different from FIG. 11, in this implementation, high MAC functionality of DU is split away and moved towards the network, and uses a split 5 F3 interface to communicate with low MAC, high PHY functionality at the DU, which in turn interfaces with the RRU that implements lower layer PHY functions of signal transmission/reception. In some preferred embodiments, the latency between hi MAC and RRU protocol layers is managed to be 50 milliseconds or lower.

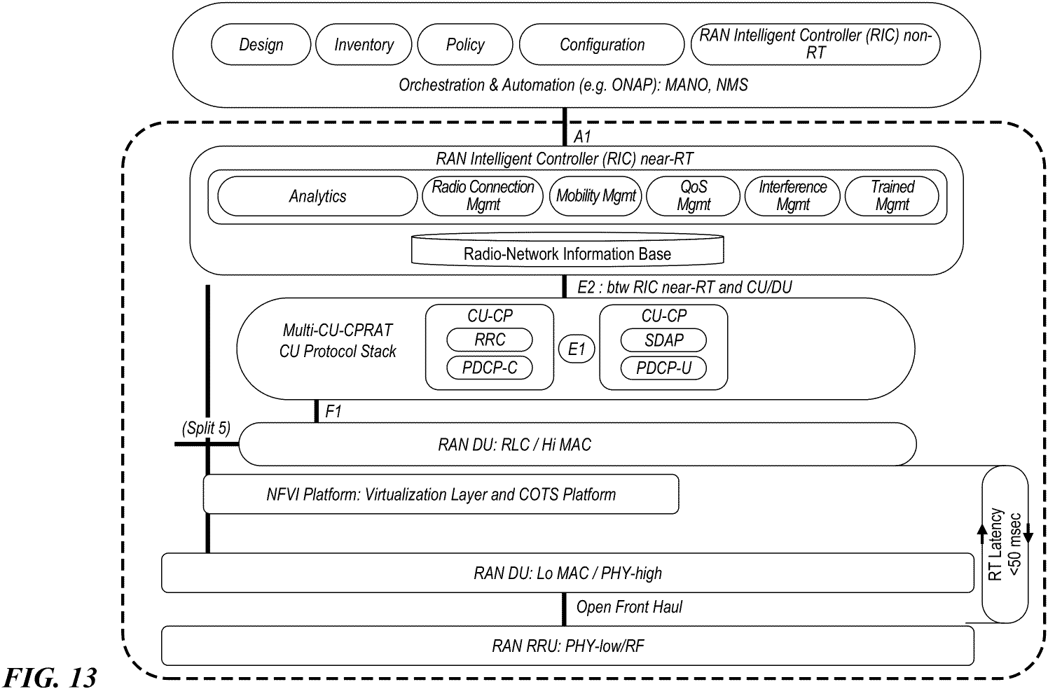

FIG. 13 shows another example embodiment that fits within an O-RAN framework. Different from FIGS. 11 and 12, in FIG. 13, the RIC is able to communicate with the lower MAC layer of the DU (e.g., precoder information) and thereby circumvents the need to go through a CU functionality. In some preferred embodiments, the latency between RLC + hi MAC layer at DU and the RRU is managed to be 50 milliseconds or lower.

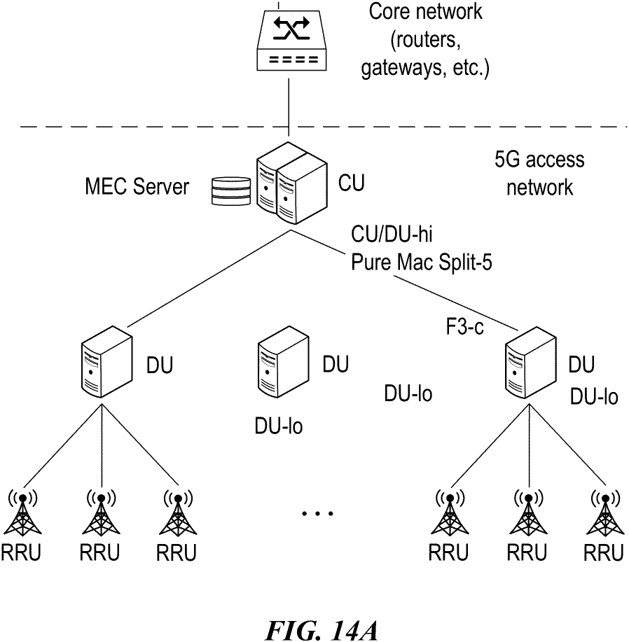

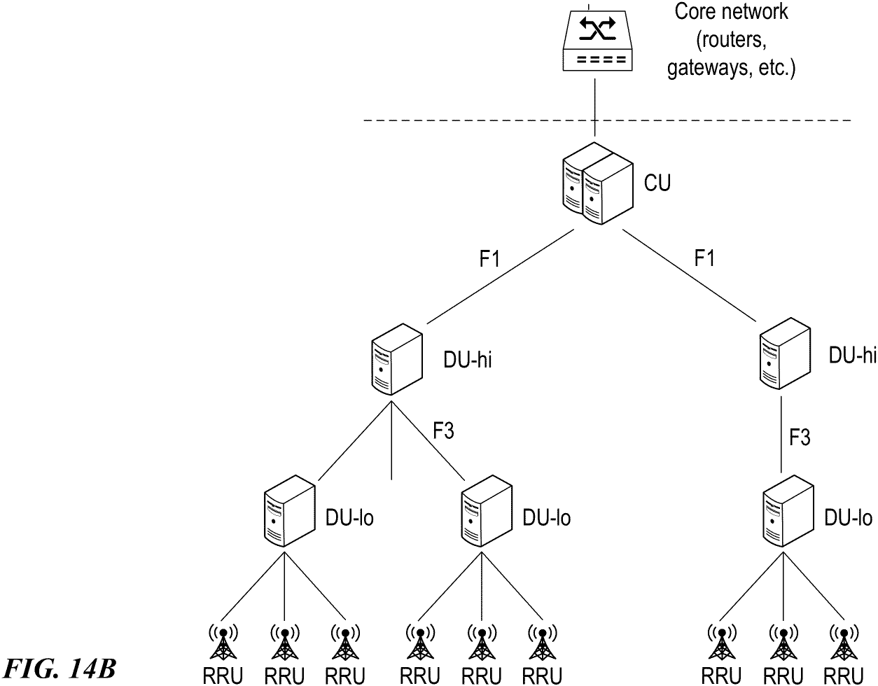

FIGS. 14A-14B show two different options for splitting implementation resources between a CU and a DU. These options are also illustrated in FIGS. 11 to 13. In FIG. 14A, an F3-c interface (or simply F3 interface) is established between low MAC functional layer at the DU and a CU/DU-hi function that is implemented using shared computational resources. By contrast, in FIG. 14B, CU and DU-hi functions are separately implemented and communicate through an F1 interface, with Du-hi and DU-low protocol layers separately implemented and communicating with each other via an F3 interface.

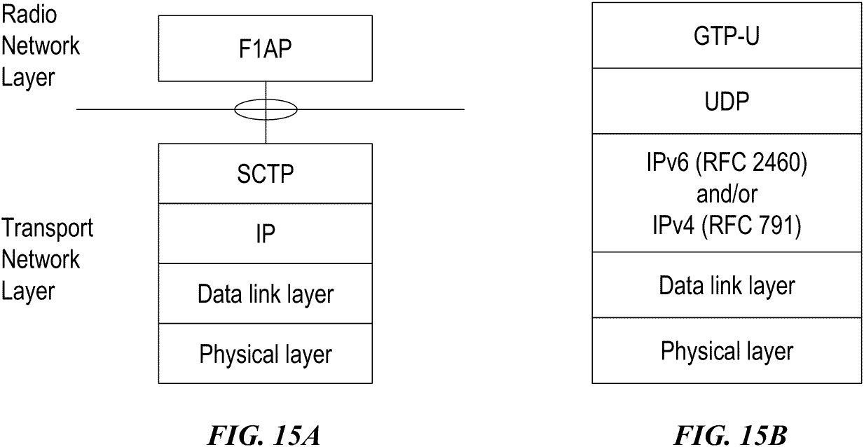

In some embodiments, the F1 (or F1-C) interface can be configured as shown in FIGS. 15A and 15B, which show the F1-C signaling bearer protocol stack and the transport network layer for data streams over F1, respectively. The F3 interface can be configured to use the same transport protocols as the F1 transport protocols.

In some embodiments, the F1-C signaling bearer protocol stack, shown in FIG. 15A, provides the following functions:
provision of reliable transfer of F1AP messages over the F1-C interface;
provision of networking and routing functions;
provision of redundancy in the signaling network; and
support for flow control and congestion control.

In some embodiments, the transport network layer for data streams over F1, shown in FIG. 15B, is an IP-based transport that includes GPRS tunneling protocol GTP-U, user datagram protocol UDP, IPv6 and/or IPv4, the data link layer, and the physical layer.

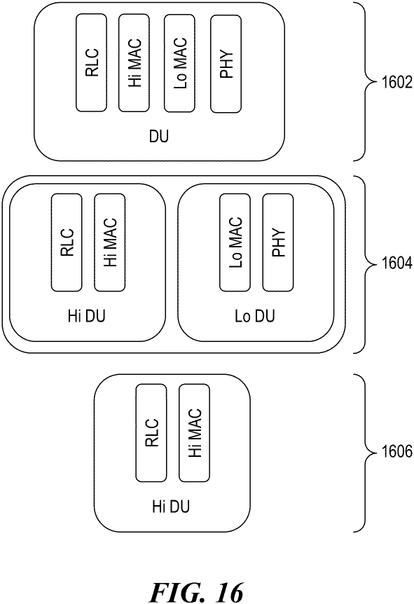

FIG. 16 shows various embodiment options for protocol stack handling, as described previously. Option 1602 includes implementation of DU at the edge, such that a complete DU is implemented including RLC, Hi MAC, Lo MAC and PHY layers, and interfaces with CU using standardized application programmer’s interface (APIs). Option 1604 includes a split DU implementation between edge and cloud. Here, Io MAC may be implemented at far edge, high MAC implemented in the cloud and is integrated with CU functionality using standardized APIs. Option 1606 is a cloud implementation in which hi DU functionality is split into RLC and Hi MAC.

### Delay-Doppler Domain Processing

As previously indicated, real time performance and reduction in computational complexity of various embodiments described herein can further be achieved using delay-Doppler domain based signal processing and the use of orthogonal time frequency space (OTFS) transform. Additional details are discussed in this section.

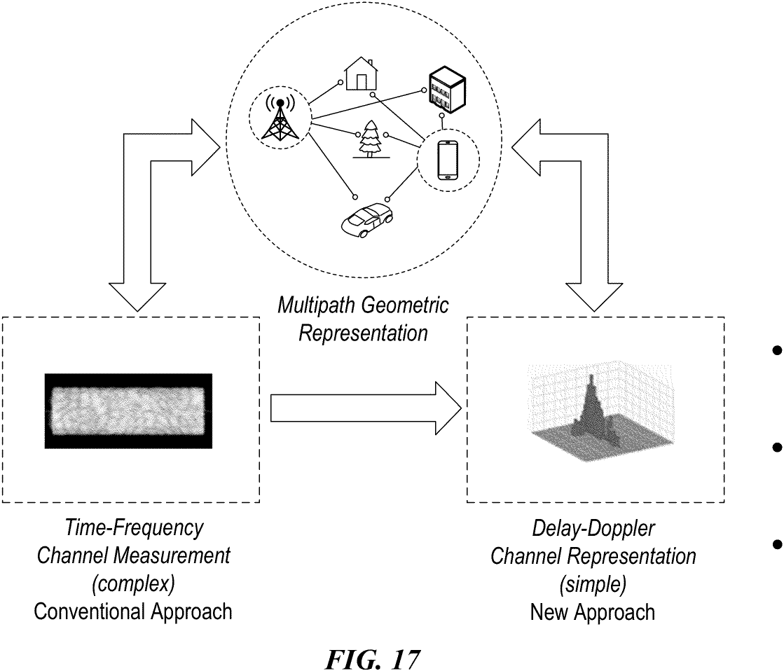

FIG. 17 shows an example of a delay-Doppler domain channel estimation. In conventional approach, channel measurements are taken in time and frequency dimensions and used for subsequently improving modulation performance on the channel. By contrast, using a delay-Doppler domain representation of a channel, dominant reflectors in a typical wireless channel can be identified. This simplified approach for modeling dominant reflectors provides the ability to use multi-user multi-input multi-output (MU-MIMO) framework for signal transmissions in which beam isolation can be achieved without a need for explicit feedback from user devices. Furthermore, the channel characteristics thus determined are aging-proof and can be used for predicting future channel conditions, thereby allowing scheduling of communication without wastage and by reducing probability of errors.

In some embodiments, channel estimation and the prediction of future channel conditions and channel quality can be implemented for the uplink and/or downlink channels. An example method of channel estimation includes estimating, based on channel quality information for a first communication channel during a first time interval, a predicted quality of a second communication channel during a second time interval that is a latency interval after the first time interval and using the predicted quality for processing transmissions on the second communication channel during the second time interval. The channel prediction may be used for implementing the scheduler function described in the present document.

### Downlink SINR (Signal to Interference and Noise Ratio) and Channel Quality Prediction

Typically, a base station receives reports from a user device on the quality of its received downlink channel. In LTE/5G, these reports are known as CQI (Channel Quality Indicator) reports, which can be scheduled periodically or on-demand and consist of quantized channel quality information for the entire band (wide-band), or for multiple sub-bands. A channel quality metric may be computed by averaging the received channel power across a specific band.

Denote the vector, Vₜᵢ = [Q₁, Q₂, ..., Q_{N}]^{T} as a vector of N ≥ 1 channel quality measurements, Qⱼ, j = 1, 2, ..., N, for a time instance tᵢ, where the index j represents different sub-bands. Note, that Qⱼ may represent SINR, average SINR, CQI or any other value, which is proportional to the channel’s received power.

A remote base station in the cloud may apply a prediction filter, C, to these measurements and compute a future quality measurements vector Vₜᵢ_{+Δt}, that represents a prediction of these values in a future time denoted by tᵢ + Δt, where Δt > 0. The prediction filter may be represented by an N × N matrix and the predicted values are then computed as

$${V}_{{t}_{i} + Δ t} = C ⋅ {V}_{{t}_{i}}$$

The following section explains how to compute this filter matrix. With future knowledge on the quality of the channel, the O-RAN can overcome the latency and make better decisions on future scheduling and thus improve the overall cell capacity.

### Examples of Prediction Filter Estimation

The prediction filter may be computed after a short training that consists of receiving one or more pairs of channel quality measurement vectors, separated by the desired latency Δt. Let K ≥ 1, be the number of training pairs. Then, the base station may collect these training pairs in two matrices:

$${\text{Θ}}_{1} = \left[{V}_{{t}_{1}} \left|{V}_{{t}_{2}}\right| … \left|{V}_{{t}_{K}}\right)\right]$$

$${\text{Θ}}_{2} = \left[{V}_{{t}_{1} + Δ t} \left|{V}_{{t}_{2} + Δ t}\right| … \left|{V}_{{t}_{K} + Δ t}\right)\right]$$

and combine them into a single matrix:

$$\text{Θ} = \left[\begin{matrix}{\text{Θ}}_{1} \\ {\text{Θ}}_{2}\end{matrix}\right] .$$

Let R be the maximum likelihood cross-covariance matrix, of dimensions 2 N × 2 N, that maximizes the probability

$$P \left(\text{Θ} \left|R\right)\right) = \frac{1}{\sqrt{{\left(2 π\right)}^{2 N} \left|R\right|}} ⋅ {e}^{- \frac{1}{2} {\text{Θ}}^{H} {R}^{- 1} \text{Θ}}$$

Note that R is composed of 4 different N × N Toeplitz sub-matrices

$$R = \left[\begin{matrix}{R}_{11} & {R}_{12} \\ {R}_{21} & {R}_{22}\end{matrix}\right]$$

The prediction filter may be computed from these sub-matrices as

$$C = {R}_{21} ⋅ {R}_{11}^{- 1}$$

The prediction filter may be used for predicting future channel quality of a same or a different channel as described herein.

### Uplink SINR and Channel Quality Prediction

The base station may apply similar techniques to predict the channel quality in the uplink as well and make decisions on future uplink scheduling, in the presence of latency. The base station may use uplink reference signals to compute the uplink received channel power and then, process it similarly to the downlink.

Various embodiments of O-RAN equipment and methods are described in the context of method 400 above. They include solutions that enable deployment of O-RAN architecture and network-side functions in a distributed manner. These solutions will also enable economies of implementation due to the ability to be able to perform highly accurate estimation of future behavior of channel. These solutions will therefore allow network operators and network equipment manufacturers to trade off amount of computational resources that need to be deployed at various locations around a wireless network. For example, equipment with slower or fewer computational resources may be deployed locally, while greater computational resources may be deployed at a remote site.

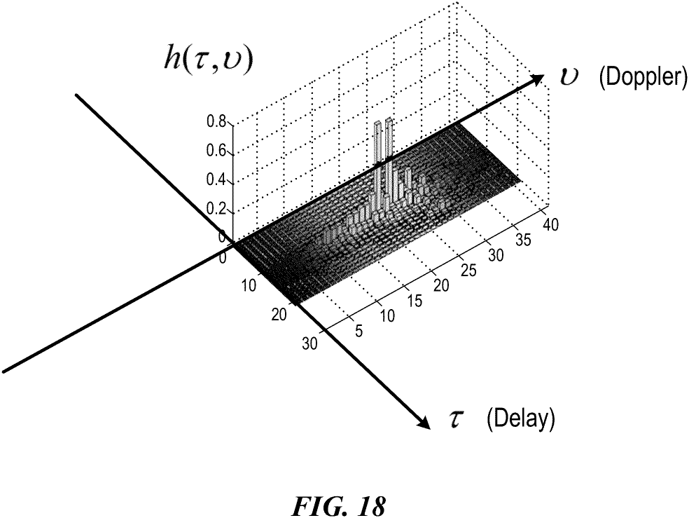

FIG. 18 shows an example of delay-Doppler domain channel representation. Using measurements from reference signals, a channel may be modeled along a delay dimension and a Doppler dimension, as depicted in FIG. 18.

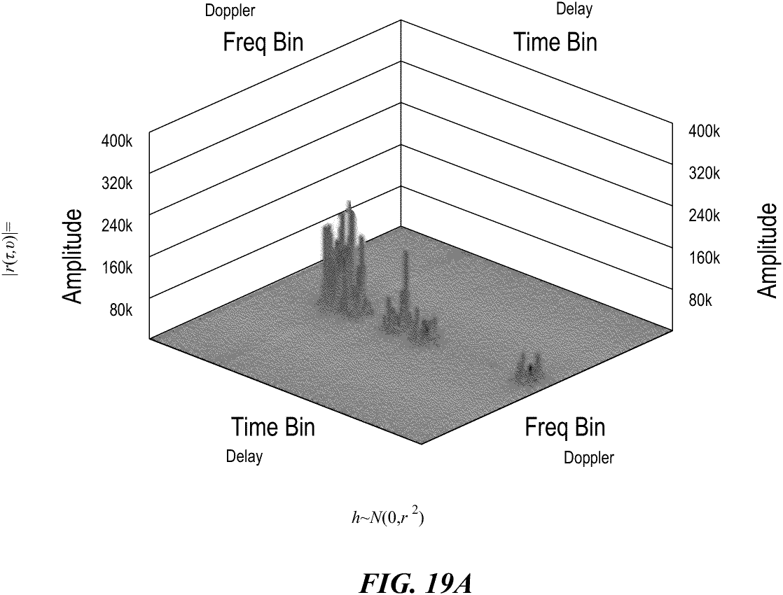

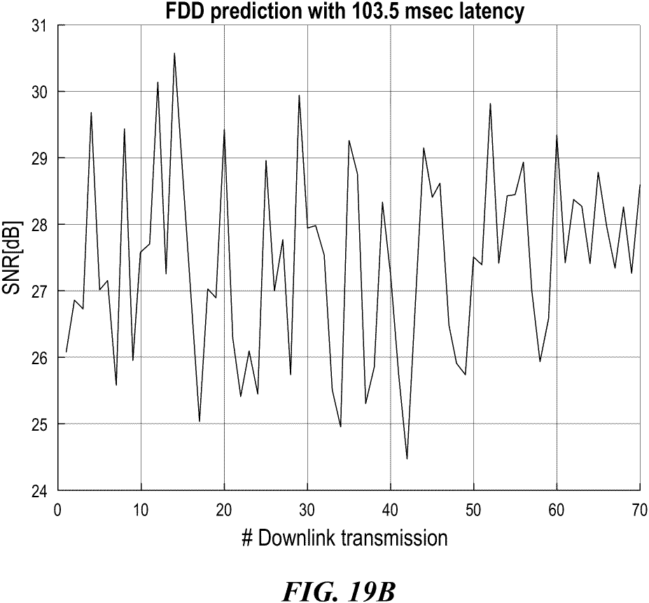

FIG. 19A shows an example of channel modeling, and FIG. 19B shows an example of prediction in the delay-Doppler domain.

In general, a wireless channel is governed by stationary parameters:
Reflector delay:
$$τ = \frac{\text{range}}{c}$$
Reflector Doppler:
$$v = f ⋅ \frac{\text{velocity}}{c}$$
Reflector propagation loss:
$$h = {e}^{j 2 π θ} \times r$$
{τ, v, r} change slowly in time and independent of carrier frequency

In the above equation, the left hand term represents reflector gain (fast varying) that is a product of reflector phase (fast varying) and reflector loss (slow varying). FIG. 19B shows the SNR for FDD (frequency division duplexing) prediction, wherein SNR is the inverse of the mean square error between the measured channel and the predicted channel. The example shown in FIG. 19B is for the 3450 - 3550 MHz frequency band and for a latency budget of 100 s of msec.

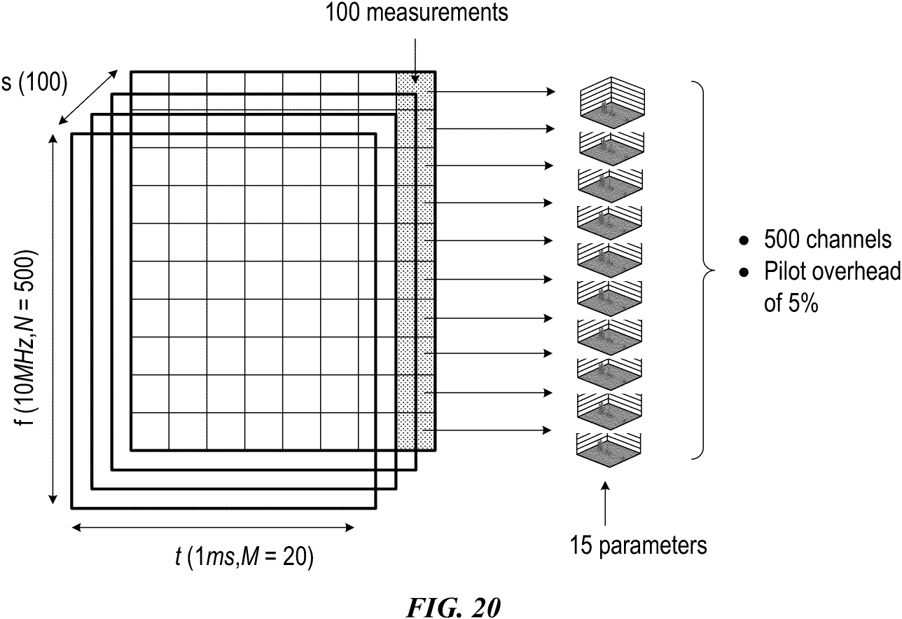

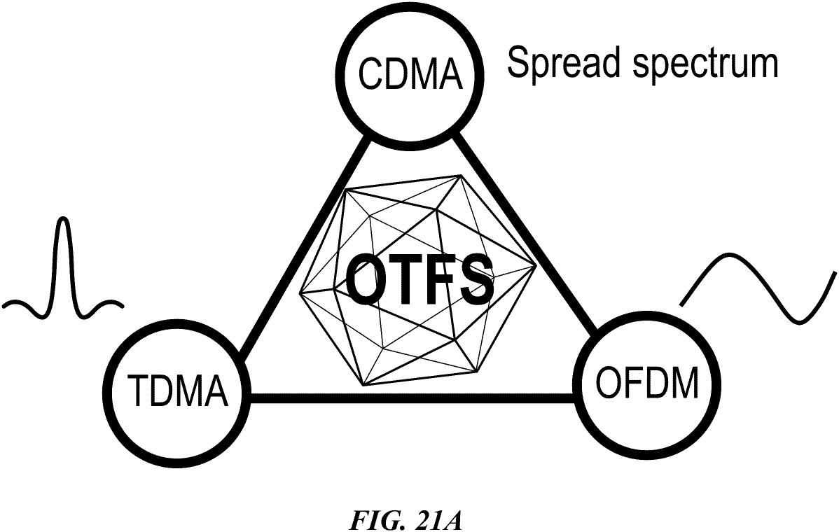

FIG. 20 shows an example of channel sensing in the delay-Doppler domain. The channel may be sensed along two dimensions, simply to determine a small number of parameters. For example, in most cases, 15 parameters or less, corresponding to dominant reflectors, may need to be determined for a wireless channel.

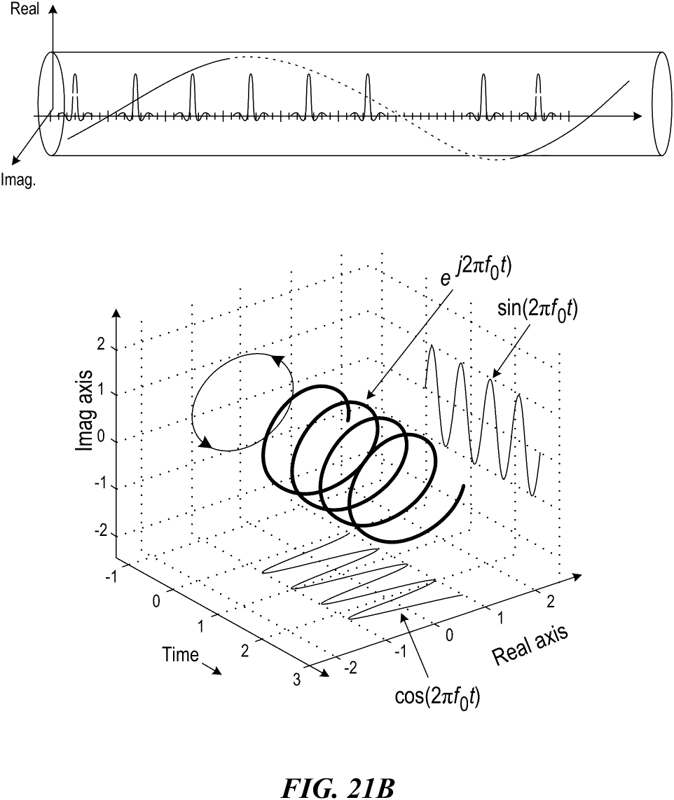

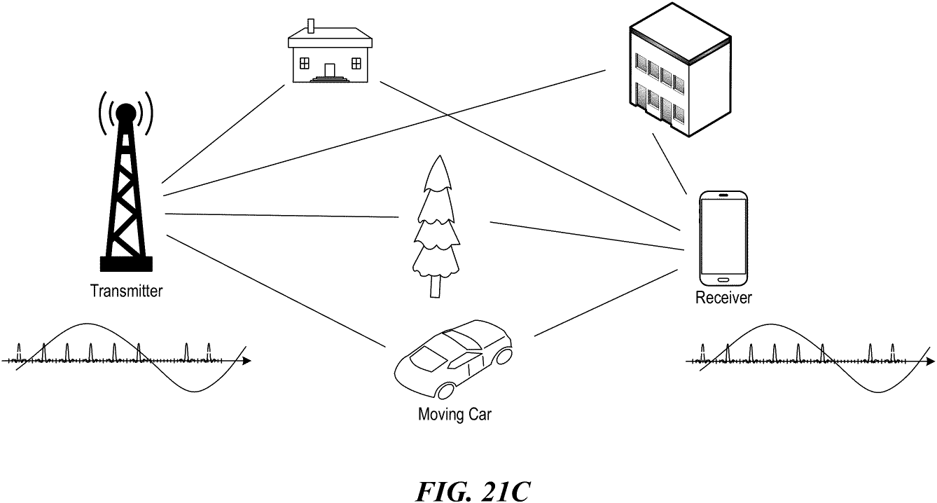

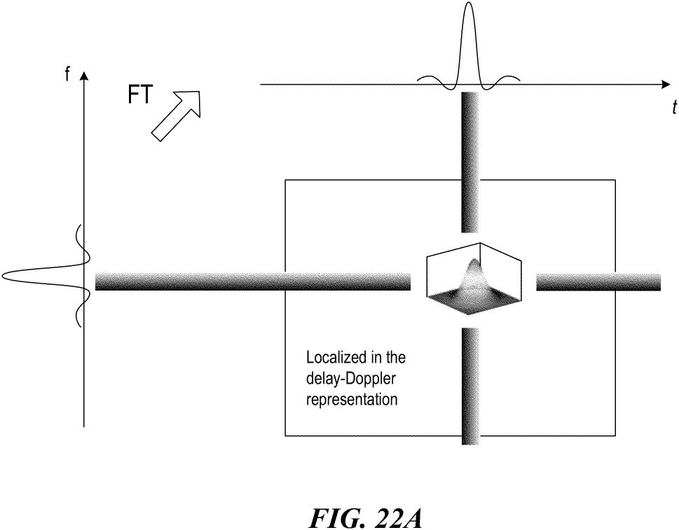

FIGS. 21A - 25B show additional details of related to the Orthogonal Time Frequency Space (OTFS) transformation.

FIG. 21A pictorially shows how OTFS based signal processing representation unifies the three conventional technical form wireless data transmissions — namely time division multiplexing (TDMA), orthogonal frequency division multiplexing (OFDM) and code division multiplexing (CDMA).

FIG. 21B pictorially shows an example of an OTFS waveform and a pictorial depiction of how an OTFS waveform stays invariant under time delay and Doppler shifts. The top graph in FIG. 21B shows time axis (horizontal) along which the waveform progresses as a train of pulses whose phase is modulated using a modulation waveform, as depicted by real and imaginary axes. The bottom graph of FIG. 21B shows a three-dimensional rendering of an OTFS waveform along real and imaginary axis as it progresses along the time axis.

FIG. 21C shows an example of a typical wireless channel - reflectors include static reflectors such as building and trees and moving reflectors such as cars. OTFS modulation is invariant to channel conditions, thereby providing performance consistency and robustness under all channel conditions.

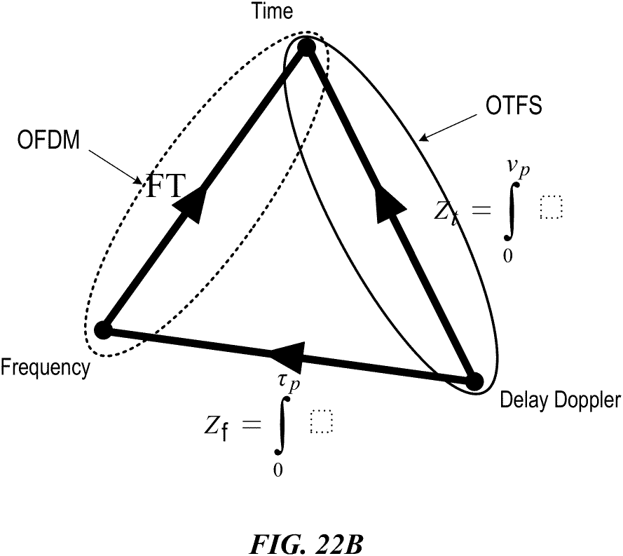

FIG. 22A is a pictorial depiction of an OTFS waveform that shows the mathematical property of an OTFS waveform that localizes time and frequency signals in a delay-Doppler domain.

FIG. 22B shows another powerful aspect of OTFS signals that allow for representation of signals using OTFS transform via a Zak transform (Z), which has half the complexity of a fast Fourier transform (FFT). As shown in FIG. 22B, the one-dimensional Zak transform can be used to transform from the delay-Doppler domain to either the time-domain (integrating over Doppler) or the frequency-domain (integrating over delay).

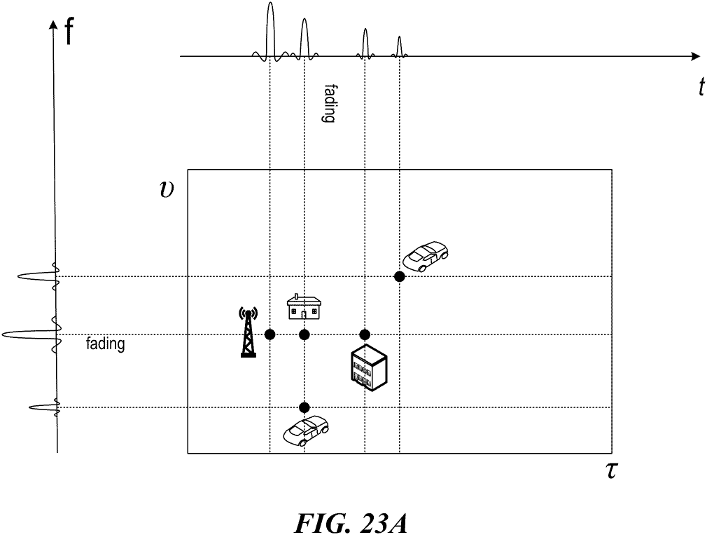

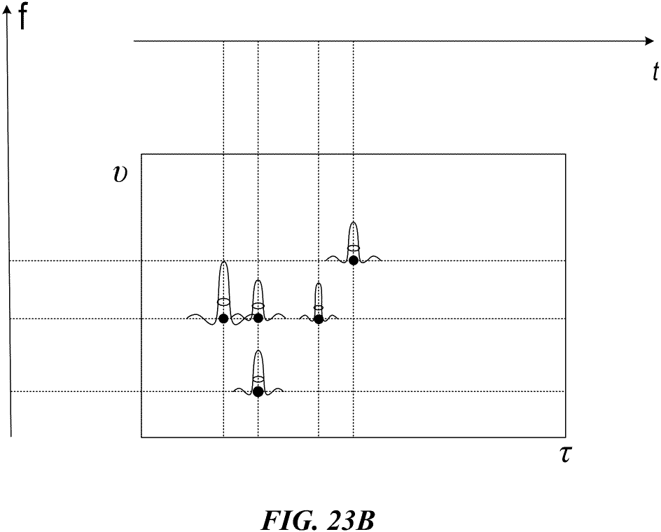

FIG. 23A pictorially shows behavior of various reflectors along time and frequency axes.

FIG. 23B is a graphical representation of the same reflectors as in FIG. 23A, but show localized in the delay-Doppler domain as single points. FIGS. 23A and 23B together show the inherent superiority of characterizing a reflector in a delay-Doppler domain compared to the conventional time-frequency domain. At least some of the benefits of using a delay-Doppler domain characterization include separability, sparsity, invariance, and predictability.

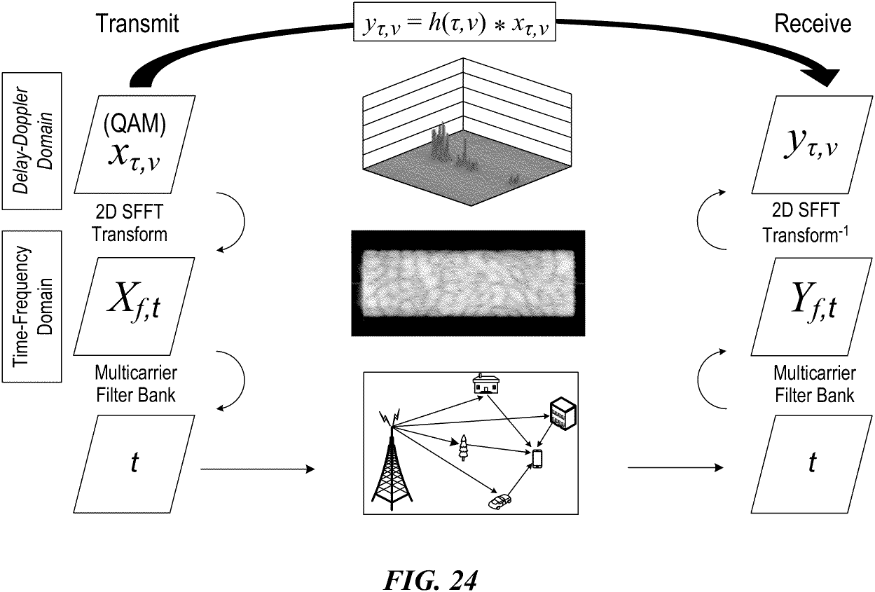

FIG. 24 shows end-to-end operation of OTFS transmission and reception. At the transmit side, quadrature amplitude modulation (QAM) symbols may be converted from the delay-Doppler domain to the time-frequency domain using an SFFT (symplectic fast Fourier transform), followed by processing through a multi-carrier filter bank and converted into a time domain waveform that is transmitted over a wireless channel. At the receiver, the waveform is received, filtered through a multicarrier filter bank to generate time-frequency samples that are processed through an inverse SFFT transform to recover delay-Doppler domain QAM symbols, which can then be decoded to recover data bits modulated into the QAM symbols.

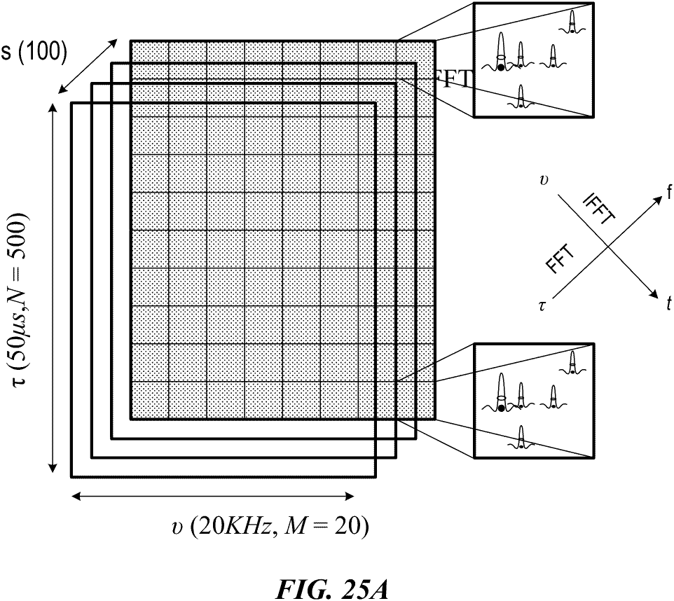

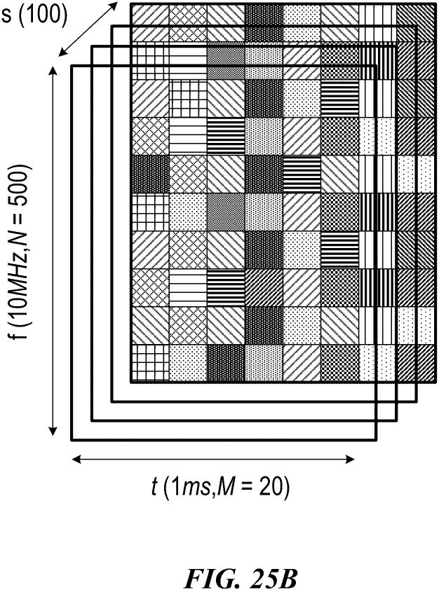

FIG. 25A shows an example of computational complexity of a channel equalization operation in delay-Doppler domain. The non-linear channel equalization requires inversion of a single matrix which holds reflector information. This matrix, for example, may have a dimension that is a product of Doppler frequency bins and time domain slots. However, by recognizing that the dominant contribution is typically only by a handful of reflectors (typically 10 or less), the complexity of matrix inversion could be significantly reduced by using mathematical tools such as principal component analysis or singular value decomposition to make the matrix-to-be-inverted friendly for inversion.

FIG. 25B shows a corresponding complexity of matrix inversion in the time-frequency domain, which requires inversion of a number of smaller dimension matrices. In the example shown in FIG. 25B, 10,000 matrix inversions (each of size 100×100) are needed. Such a

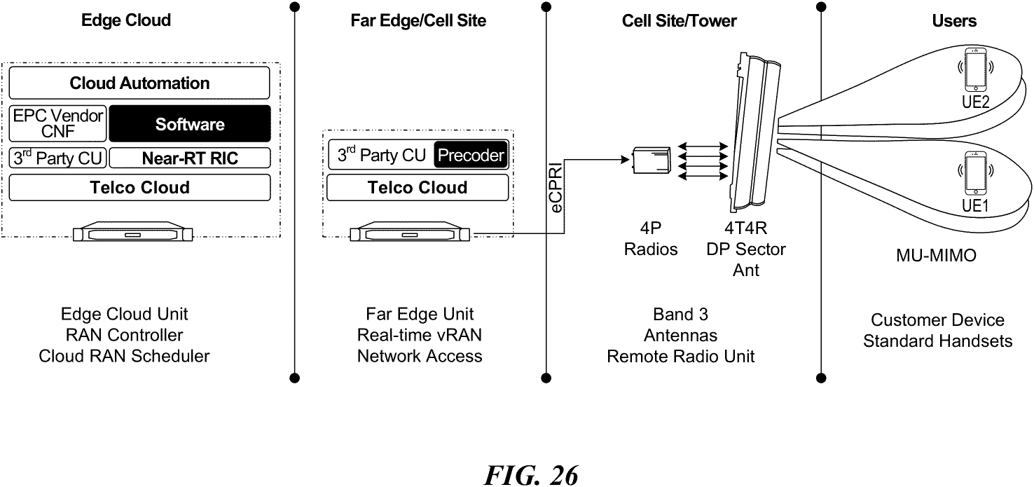

FIG. 26 shows an example system architecture in a wireless network. In this embodiment, a scheduler software in the edge cloud is controlling scheduling operations in a network, including MU-MIMO beam forming with user devices.

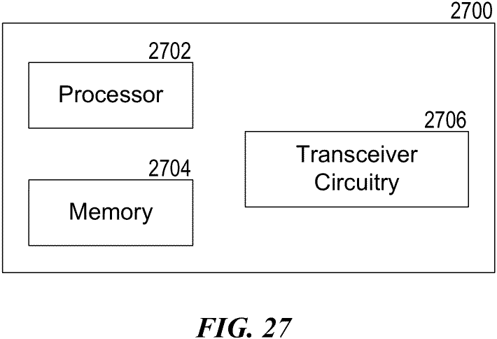

FIG. 27 shows a hardware platform 2700 that may be used for implementing various functions disclosed in the present document. The hardware platform 2700 includes one or more processors 2702, an optional storage or memory 2704 and transceiver circuitry 2706 for data communication. The processor 2702 are configured to implement various techniques described herein. The memory 2704 may store processor executable code and/or input or output data for processor-based processing and may be internal to the processor(s) 2702 and/or external to the processor. The transceiver circuitry 2706 may implement communication protocols for transmission and/or reception of data such as using a wired or wireless protocol.

It will be appreciated that various embodiments of a wireless network and a method implemented in the wireless network are described. In these embodiments, a CU may be connected to one or more DUs for operation of the wireless network.

Some of these embodiments may implement a Split 5 architecture (e.g., as shown in FIGS. 5A and 5B) in which the MAC layer is partitioned into two parts: a high part (RLC layer and some of the MAC) and a low part (remaining parts of MAC) connected to the PHY layer. It will be appreciated that a new interface called F3 interface is disclosed. Using the F3 interface, messages may be transmitted from high MAC to low MAC. These messages may include Scheduling and spatial multiplexing information, Multi-user spatial precoding coefficients, Data & Control and UL channel estimation/information.

It will further be appreciated that the F3 interface allows for low MAC to high MAC transmissions including, for example, data and control, downlink channel information such as signal quality reports or channel state information reports, and ACK/NACK signals.

It will further be appreciated that techniques are described to allow partitioning of a scheduling function A scheduler for one part of the available resources in the CU and a scheduler for the other part of the available resources in the DU. In some embodiments, the operation of scheduler may take into account the prediction latency across CU DU interface such that the channel prediction is reliably perform for future transmissions. In some embodiments, CU schedules transmissions for multi-user over different spatial layers and DU schedules single users for time critical transmissions. In some embodiment, CU may co-schedule transmissions for multiple DUs.

It will also be appreciated that several techniques for handling HARQ transmissions and retransmissions are disclosed. Some embodiments may disable HARQ by ignoring NACK at low MAC & PHY layers. Instead, lower MCS and apply automatic scheduling of additional retransmissions when MCS cannot be lowered (proactive HARQ). For example, such embodiments may pass NACK from the lower MAC layer to the higher MAC layer to reduce latency of RLC retransmissions. Some embodiments use DU scheduler to schedule HARQ retransmission if there are enough available resource. If not, ignore the NACK indicator at low MAC & PHY layers.

It will further be appreciated that the present document discloses operation of a wireless network using a Split 2 architecture in which PDCP layer (in CU) and RLC layer (in DU) are split, and communicate via an F1 interface. Here, some embodiments may implement duplicate RLC layer for both sides of the split and implement the scheduler at the PDCP side (cloud) based on the duplicated RLC output. In some implementations, the F1 interface may be modified to include the scheduler information along with the PDCP data and control. In one advantageous aspect, the use of duplicate RLC can be leveraged to rely on a standardized interface like F1 with minimal changes (e.g. scheduling information transmitted as proprietary information compatible with legacy F1 syntax). In such configurations, because a duplicate RLC is maintained at both ends of the F1 interface, interlayer communication latency can be reduced compared to not implementing the duplicate RLC.

One additional advantage of some of the disclosed embodiments is that the flexible partitioning of protocol stack layers allows for ensuring system latency in gathering channel data, and generating schedules can be kept to within a threshold (e.g. one TTI), by assigning tasks according to available computational power. Furthermore, as described with respect to reflector-based identification of channel, also called geometric interpretation of a channel, allows for relatively low computational complexity in determining transmissions schedules. The schedule can be extended to other times (e.g., future TTIs) or other frequency bands, based on identification of dominant reflectors of the channel.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read -only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method of wireless communication, comprising:
determining, using resources in a wireless network, a schedule of transmissions between the wireless network and one or more user devices, wherein the resources are distributed between a central unit (CU) and multiple distributed units (DUs) according to a resource partitioning scheme such that the DUs are configured to handle a first set of protocol layers of a communication protocol stack implemented in the wireless network according to a layer partitioning scheme and the CU is configured to handle a second set of protocol layers of the communication protocol stack according to the layer partitioning scheme; and
controlling the transmissions according to the schedule of transmission, wherein the schedule of transmission is determined at the CU;
wherein the first set of protocol layers excludes an upper medium access control (MAC) layer, and
wherein the second set of protocol layers excludes a physical layer.

2. The method of claim 1, wherein the layer partitioning scheme disables handling of hybrid automatic repeat requests (HARQ) by the multiple DUs.

3. The method of claim 1, wherein the schedule of transmissions is determined by:
predicting a channel condition of a channel between the wireless network and a user device at a future time; and
determining a modulation and coding scheme (MCS) for a future transmission at the future time on the channel based on the predicted channel condition.

4. The method of claim 1, further comprising:
receiving an acknowledgement/negative acknowledgement (ACK/NACK) transmission from the one or more wireless device; and
refraining, in response to the ACK/NACK transmission, retransmitting data based on the ACK/NACK transmission from the first set of protocol layers.

5. The method of claim 4, further comprising:
processing the ACK/NACK transmission at the second set of protocol layers; and
performing a retransmission based on the processing at the second set of protocol layers.

6. The method of claim 1, wherein the resource partitioning scheme is dynamically changing with a granularity of one transmit time interval (TTI).

7. The method of claim 6, further comprising:
handling, by the multiple DUs, HARQ retransmissions based on an acknowledgement/negative acknowledgement (ACK/NACK) transmission received from the one or more user devices, selectively based on the resources available at the multiple DUs according to the resource partitioning scheme.

8. The method of claim 1, wherein the layer partitioning scheme configures the multiple DUs to handle initial access, service requests, and HARQ transmissions, and the CU to handle remaining data and control transmissions.

9. The method of claim 1, wherein the layer partitioning scheme comprises a first scheme in which the upper MAC layer and layers above the upper MAC layer are implemented at the CU and a lower MAC layer and layers below the lower MAC layer are implemented at the multiple DUs, or a second scheme in which a packet data convergence protocol (PDCP) layer and layers above the PDCP layer are implemented at the CU and a radio link control layer (RLC) and layers below the RLC layer are implemented at the multiple DUs, the method further including establishing a communication interface between the upper MAC layer and the lower MAC layer, wherein the communication interface is configured to carry user data, control data, and scheduling information.

10. The method of claim 9, further comprising:
implementing, in a cloud, a duplicate copy of the RLC at the multiple DUs,
wherein a communication between the PDCP layer and the RLC layer is compliant with a legacy protocol.

11. A system for wireless communication, comprising:
a central unit (CU) and multiple distributed units (DUs), and a processor,
wherein the processor is configured to determine, using resources in a wireless network, a schedule of transmissions between the wireless network and one or more user devices,
wherein the resources are distributed between the CU and multiple DUs according to a resource partitioning scheme such that the DUs are configured to handle a first set of protocol layers of a communication protocol stack implemented in the wireless network according to a layer partitioning scheme and the CU is configured to handle a second set of protocol layers of the communication protocol stack according to the layer partitioning scheme; and
control the transmissions according to the schedule of transmission;
wherein the first set of protocol layers excludes an upper medium access control (MAC) layer, and
wherein the second set of protocol layers excludes a physical layer.

12. The system of claim 11, wherein the layer partitioning scheme disables handling of hybrid automatic repeat requests (HARQ) by the multiple DUs.

13. The system of claim 11, wherein the schedule of transmission is determined by:
predicting a channel condition of a channel between the wireless network and a user device at a future time; and
determining a modulation and coding scheme (MCS) for a future transmission at the future time on the channel based on the predicted channel condition.

14. The system of claim 11, wherein:
upon receiving an acknowledgement/negative acknowledgement (ACK/NACK) transmission from the one or more wireless device; the system refrains, in response to the ACK/NACK transmission, retransmitting data based on the ACK/NACK transmission from the first set of protocol layers.

15. The system of claim 14, wherein:
the ACK/NACK transmissions are processed at the second set of protocol layers; and
retransmissions are performed based on the processing at the second set of protocol layers.

16. The system of claim 11, wherein the resource partitioning scheme is dynamically changed with a granularity of one transmit time interval (TTI).

17. The system of claim 16, wherein:
the multiple DUs are configured to handle HARQ retransmissions based on an acknowledgement/negative acknowledgement (ACK/NACK) transmission received from the one or more user devices, selectively based on the resources available at the multiple DUs according to the resource partitioning scheme.

18. The system of claim 11, wherein the layer partitioning scheme configures the multiple DUs to handle initial access, service requests, and HARQ transmissions, and the CU to handle remaining data and control transmissions.

19. The system of claim 11, wherein the layer partitioning scheme comprises a first scheme in which the upper MAC layer and layers above the upper MAC layer are implemented at the CU and a lower MAC layer and layers below the lower MAC layer are implemented at the multiple DUs, or a second scheme in which a packet data convergence protocol (PDCP) layer and layers above the PDCP layer are implemented at the CU and a radio link control layer (RLC) and layers below the RLC layer are implemented at the multiple DUs, and the system includes a communication interface between the upper MAC layer and the lower MAC layer, wherein the communication interface is configured to carry user data, control data, and scheduling information.

20. The system of claim 19, wherein:
the processor is a cloud computing resource and a duplicate copy of the RLC at the multiple DUs is implemented using the cloud computing resource,
wherein a communication between the PDCP layer and the RLC layer is compliant with a legacy protocol.
